(19) United States
(12) Patent Application Publication
(10) Pub. No.: US 2023/0343293 A1
(43) Pub. Date: Oct. 26, 2023

(54) PIXEL CIRCUIT AND DISPLAY PANEL

(71) Applicant: Yungu (Gu’an) Technology Co., Ltd., Langfang (CN)

(72) Inventors: Cuili GAI, Langfang (CN); Enqing GUO, Langfang (CN); Kangguan PAN, Langfang (CN); Junfeng LI, Langfang (CN); Rubo XING, Langfang (CN); Fa-Hsyang CHEN, Langfang (CN)

(73) Assignee: Yungu (Gu’an) Technology Co., Ltd., Langfang (CN)

(21) Appl. No.: 18/342,033

(22) Filed: Jun. 27, 2023

Related U.S. Application Data
(63) Continuation of application No. PCT/CN2022/101912, filed on Jun. 28, 2022.

(30) Foreign Application Priority Data
Jun. 30, 2021 (CN) 202110738517.0
Jul. 15, 2021 (CN) 202110800273.4

(51) Int. Cl. G09G 3/3233; G09G 3/3291

(52) U.S. Cl. CPC G09G 3/3233; G09G 3/3291; G09G 2300/0842; G09G 2330/021; G09G 2320/0247

(57) ABSTRACT

A pixel circuit, a display panel and a display device. A light-emitting control module of the pixel circuit is configured to control, based on a signal on a light-emitting control signal line, a light-emitting module to emit light according to a drive current output by a drive module. A first initialization module is configured to write an initialization voltage to a control terminal of the drive module according to a signal on a first scanning line. A first terminal of a compensation module is connected to a first terminal of the drive module, a second terminal of the compensation module is connected to the control terminal of the drive module through a leakage suppression module, and the compensation module is configured to perform threshold compensation for the drive module according to a signal on a second scanning line.

### CROSS-REFERENCE TO RELATED APPLICATION

The present application is a continuation of International Application No. PCT/CN2022/101912 filed on Jun. 28, 2022, which claims priority to Chinese Patent Application No. 202110738517.0, filed on Jun. 30, 2021 and entitled “PIXEL CIRCUIT AND DISPLAY PANEL”, and Chinese Patent Application No. 202110800273.4, filed on Jul. 15, 2021 and entitled “PIXEL CIRCUIT, DISPLAY PANEL AND DISPLAY DEVICE”, both of which are hereby incorporated by reference in their entireties.

### TECHNICAL FIELD

The present application relates to a technical field of display, and particularly relates to a pixel circuit and a display panel.

### BACKGROUND

As the demand for longer standby time for the display increases, the low-frequency display is the trend. The display panel usually includes a pixel circuit, and the pixel circuit includes a drive transistor. The drive transistor is configured to drive the light-emitting device to emit light, thereby realizing the display of the screen.

Low-temperature polysilicon transistors have the advantages of high mobility, strong drive ability and low process cost, and thus are widely used as drive transistors. However, the leakage current of the low-temperature polysilicon transistor is large, and when the low-frequency display is performed, the light-emitting time in a frame becomes longer, which increases the leakage time of the transistor in the pixel circuit. Therefore, it is easy to cause instability of the gate voltage of the drive transistor in the pixel circuit, and then cause the problem of screen flashing under the working condition of low refresh frequency.

### SUMMARY

Embodiments of the present application provide a pixel circuit and a display panel, which can improve the voltage holding ratio of the storage module, and mitigate the flashing phenomenon of the light-emitting module.

In a first aspect, an embodiment of the present application provides a pixel circuit including a drive module, a storage module, a compensation module, a first initialization module, a light-emitting module, a light-emitting control module and a leakage suppression module; wherein the storage module is connected to a control terminal of the drive module, and is configured to store a voltage of the control terminal of the drive module; the light-emitting control module, the drive module and the light-emitting module are connected between a first power line and a second power line, and the light-emitting control module is configured to control, based on a signal on a light-emitting control signal line, the light-emitting module to emit light according to a drive current output by the drive module; a first terminal of the first initialization module is connected to an initialization signal line, a second terminal of the first initialization module is connected to the control terminal of the drive module through the leakage suppression module, and the first initialization module is configured to write an initialization voltage provided by the initialization signal line to the control terminal of the drive module according to a signal on a first scanning line; a first terminal of the compensation module is connected to a first terminal of the drive module, a second terminal of the compensation module is connected to the control terminal of the drive module through the leakage suppression module, and the compensation module is configured to perform threshold compensation for the drive module according to a signal on a second scanning line.

In a second aspect, based on a same inventive concept, an embodiment of the present application provides a pixel circuit including a drive module, a storage module, a compensation module, a first initialization module, a light-emitting module, a light-emitting control module and a leakage suppression module; wherein the storage module is connected to a control terminal of the drive module, and is configured to store a voltage of the control terminal of the drive module; the light-emitting control module, the drive module and the light-emitting module are connected between a first power line and a second power line, and the light-emitting control module is configured to control, based on a signal on a light-emitting control signal line, the light-emitting module to emit light according to a drive current output by the drive module; a first terminal of the first initialization module is connected to an initialization signal line, a second terminal of the first initialization module is connected to a first terminal of the leakage suppression module, and the first initialization module is configured to write an initialization voltage provided by the initialization signal line to the control terminal of the drive module according to a signal on a first scanning line; a first terminal of the compensation module is connected to a first terminal of the drive module, a second terminal of the compensation module is connected to a second terminal of the leakage suppression module, and the compensation module is configured to perform threshold compensation for the drive module according to a signal on a second scanning line; a third terminal of the leakage suppression module is connected to the control terminal of the drive module, and at least one of the first terminal and the second terminal of the leakage suppression module is connected with a capacitor.

In a third aspect, based on a same inventive concept, an embodiment of the present application provides a pixel circuit including a drive module, a storage module, a compensation module, a light-emitting module, a light-emitting control module and a leakage suppression module; wherein the storage module is connected to a control terminal of the drive module, and is configured to store a voltage of the control terminal of the drive module; the light-emitting control module, the drive module and the light-emitting module are connected between a first power line and a second power line, and the light-emitting control module is configured to control, based on a signal on a light-emitting control signal line, the light-emitting module to emit light according to a drive current output by the drive module; a first terminal of the compensation module is connected to a first terminal of the drive module, a second terminal of the compensation module is connected to the control terminal of the drive module through the leakage suppression module, and the compensation module is configured to perform threshold compensation for the drive module according to a signal on a second scanning line; at least one of a first terminal and a second terminal of the leakage suppression module is connected with a capacitor.

In a fourth aspect, based on a same inventive concept, an embodiment of the present application provides a pixel circuit including a drive module, a storage module, a first initialization module, a light-emitting module, a light-emitting control module and a leakage suppression module; wherein the storage module is connected to a control terminal of the drive module, and is configured to store a voltage of the control terminal of the drive module; the light-emitting control module, the drive module and the light-emitting module are connected between a first power line and a second power line, and the light-emitting control module is configured to control, based on a signal on a light-emitting control signal line, the light-emitting module to emit light according to a drive current output by the drive module; a first terminal of the first initialization module is connected to an initialization signal line, a second terminal of the first initialization module is connected to the control terminal of the drive module through the leakage suppression module, and the first initialization module is configured to write an initialization voltage provided by the initialization signal line to the control terminal of the drive module according to a signal on a first scanning line; at least one of a first terminal and a second terminal of the leakage suppression module is connected with a capacitor.

In a fifth aspect, based on a same inventive concept, an embodiment of the present application provides a display panel including one or more pixel circuits, wherein the pixel circuit includes a drive module, a leakage suppression module, a first initialization module and a compensation module; the first initialization module and the compensation module are connected to a control terminal of the drive module through the leakage suppression module, the compensation module includes a first submodule and a second submodule, and the second submodule is connected to the leakage suppression module through the first submodule; the leakage suppression module includes an eighth transistor, the first submodule includes a ninth transistor, a gate of the eighth transistor and a gate of the ninth transistor are connected to a same signal line, an active layer of the eighth transistor and an active layer of the ninth transistor are connected by a first connection part, and the first connection part, the active layer of the eighth transistor and the active layer of the ninth transistor are located in a same film layer, wherein the first connection part is a semiconductor connection part.

According to the pixel circuit and the display panel provided by the embodiments of the present application, by disposing the leakage suppression module between the control terminal of the drive module and the first initialization module as well as between the control terminal of the drive module and the compensation module, it is equivalent to reduce the leakage path at the control terminal of the drive module, so that there is only one leakage path at the control terminal of the drive module. Compared with the existence of multiple leakage paths at the control terminal of the drive module, it can make the potential of the control terminal of the drive module more stable, and mitigate the flashing problem of the display panel. On the other hand, the first node is not directly connected to the second terminal of the drive module, and a compensation module is disposed there between. Compared with the direct connection between the first node and the second terminal of the drive module, the compensation module has a larger resistance. Therefore, in the light-emitting stage, the potential of the first node can be avoided from being equal to the potential of the second terminal of the drive module, thereby avoiding a large potential difference between the control terminal of the drive module and the first node. Thus, it can be avoided from causing a large leakage current at the control terminal of the drive module through the leakage suppression module, thereby further improving the stability of the potential of the control terminal of the drive module, and further mitigating the flashing problem of the display panel. On the other hand, the control terminal of the leakage suppression module and the control terminal of the first submodule are electrically connected to the second light-emitting control signal line, and thus the electrical connection between the leakage suppression module and the first submodule can be realized without setting the hole in the layout design, which is equivalent to reduce the number of holes in the layout design, thereby improving the space utilization rate, and facilitating the formation of high-resolution display panels.

### BRIEF DESCRIPTION OF THE DRAWINGS

Other features, purposes and advantages of the present application will be more apparent by reading the following detailed description of the non-restrictive embodiments with reference to the drawings. Here, the same or similar reference numbers indicate the same or similar features, and the drawings are not drawn to actual scale.

FIG. 1 is a schematic structural diagram of a pixel circuit according to a contrasting example;

FIG. 2 is a schematic structural diagram of a pixel circuit provided by an embodiment of the present application;

FIG. 3 is a schematic structural diagram of another pixel circuit provided by an embodiment of the present application;

FIG. 4 is a schematic structural diagram of another pixel circuit provided by an embodiment of the present application;

FIG. 5 is a schematic structural diagram of another pixel circuit provided by an embodiment of the present application;

FIG. 6 is a timing diagram of a leakage control signal line and a light-emitting control signal line provided by an embodiment of the present application;

FIG. 7 is a schematic structural diagram of another pixel circuit provided by an embodiment of the present application;

FIG. 8 is a timing diagram of a pixel circuit provided by an embodiment of the present application;

FIG. 9 is a schematic structural diagram of another pixel circuit provided by an embodiment of the present application;

FIG. 10 is a simulated signal waveform diagram provided by an embodiment of the present application;

FIG. 11 is a schematic structural diagram of another pixel circuit provided by an embodiment of the present application;

FIG. 12 is a timing diagram of another pixel circuit provided by an embodiment of the present application;

FIG. 13 illustrates a schematic structural diagram of a display panel provided by an embodiment of the present application;

FIG. 14 illustrates a schematic cross-sectional diagram of an A-A direction in FIG. 13;

FIG. 15 illustrates a schematic cross-sectional diagram of a B-B direction in FIG. 13;

FIG. 16 illustrates a schematic structural diagram of a pixel circuit in a display panel provided by an embodiment of the present application;

FIG. 17 illustrates a schematic structural diagram of a pixel circuit in a display panel provided by another embodiment of the present application;

FIG. 18 illustrates a timing diagram of a pixel circuit in a display panel provided by an embodiment of the present application;

FIG. 19 illustrates a schematic local structure diagram of a display panel provided by an embodiment of the present application;

FIG. 20 illustrates a schematic cross-sectional diagram of a C-C direction in FIG. 19;

FIG. 21 illustrates a schematic structural diagram of a pixel circuit according to a contrasting example;

FIG. 22 illustrates a schematic structural diagram of a pixel circuit according to another contrasting example;

FIG. 23 illustrates a schematic structural diagram of a pixel circuit according to another contrasting example;

FIG. 24 illustrates a schematic local structure diagram of a display panel according to a contrasting example;

FIG. 25 illustrates a schematic cross-sectional diagram of a D-D direction in FIG. 24;

FIG. 26 illustrates a schematic structural diagram of a pixel circuit in a display panel provided by another embodiment of the present application;

FIG. 27 illustrates a schematic local structure diagram of a display panel provided by another embodiment of the present application;

FIG. 28 and FIG. 29 illustrate a schematic structural diagram of a pixel circuit in a display panel provided by another embodiment of the present application respectively;

FIG. 30 illustrates a schematic local structure diagram of a display panel provided by another embodiment of the present application;

FIG. 31 illustrates a schematic cross-sectional diagram of a E-E direction in FIG. 30;

FIG. 32 illustrates a timing diagram of a pixel circuit in a display panel provided by another embodiment of the present application;

FIG. 33 illustrates a schematic local structure diagram of a display panel provided by another embodiment of the present application;

FIG. 34 illustrates a schematic structure diagram of a pixel circuit in a display panel provided by another embodiment of the present application;

FIG. 35 illustrates a schematic structure diagram of a display device provided by an embodiment of the present application.

### DETAILED DESCRIPTION

Features and exemplary embodiments of various aspects of the present application are described in detail below. In order to clarify the purposes, technical solutions and advantages of the present application, the present application will be further described in detail below in combination with the accompanying drawings and specific embodiments. It should be understood that the specific embodiments described herein are intended to interpret the present application and not to limit the present application. For those skilled in the art, the present application may be practiced without some of these specific details. The following description of the embodiments is merely to provide a better understanding of the present application by illustrating examples of the present application.

It should be noted that in the present application, relationship terms such as first and second are merely used to distinguish one entity or operation from another entity or operation, and do not necessarily require or imply the existence of any such actual relationship or order between such entities or operations.

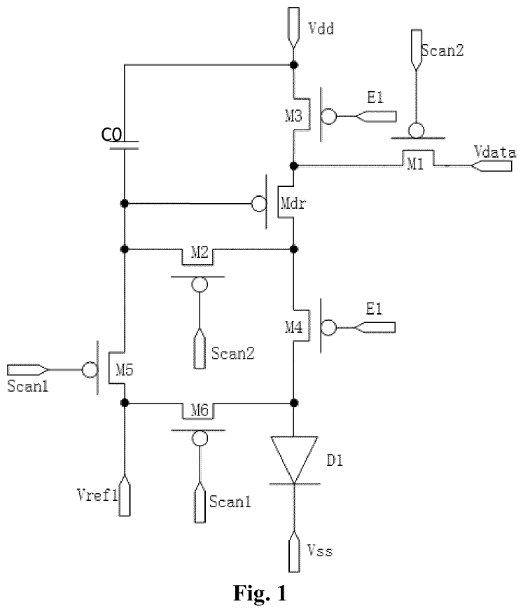

FIG. 1 is a schematic structural diagram of a pixel circuit according to a contrasting example. As shown in FIG. 1, the pixel circuit includes a drive transistor Mdr, a first switch transistor M1, a second switch transistor M2, a third switch transistor M3, a fourth switch transistor M4, a fifth switch transistor M5, a sixth switch transistor M6, a capacitor C0, and a light-emitting device D1. The drive transistor Mdr, the first switch transistor M1, the second switch transistor M2, the third switch transistor M3, the fourth switch transistor M4, the fifth switch transistor M5, and the sixth switch transistor M6 are all P-type transistors. A first electrode of the fifth switch transistor M5 is connected to a reference voltage signal line Vrefl, and a first electrode of the first switch transistor M1 is connected to a data signal line Vdata. In a working process of the pixel circuit, in a light-emitting stage, a first scanning signal provided by a first scanning signal input terminal Scan1 is a high level, a second scanning signal provided by a second scanning signal input terminal Scan2 is a high level, and a light-emitting control signal provided by a light-emitting control signal input terminal μl is a low level. At this time, the third switch transistor M3 and the fourth switch transistor M4 are turned on, and the third switch transistor M3 outputs a first power voltage provided by a first power line Vdd to a source of the drive transistor Mdr. A cathode of the light-emitting device D1 is electrically connected to a second power line Vss, and then the drive transistor Mdr provides a drive current to the light-emitting device D1 to drive the light-emitting device D1 to emit light. In the light-emitting stage, the second switch transistor M2 and the fifth switch transistor M5 are turned off, but the second switch transistor M2 and the fifth switch transistor M5 have leakage currents. The two leakage paths reduce the voltage at the gate of the drive transistor Mdr, thereby causing a change of the drive current output by the drive transistor Mdr, and resulting in the flashing problem of the light-emitting device D1 when the light-emitting device D1 emits light.

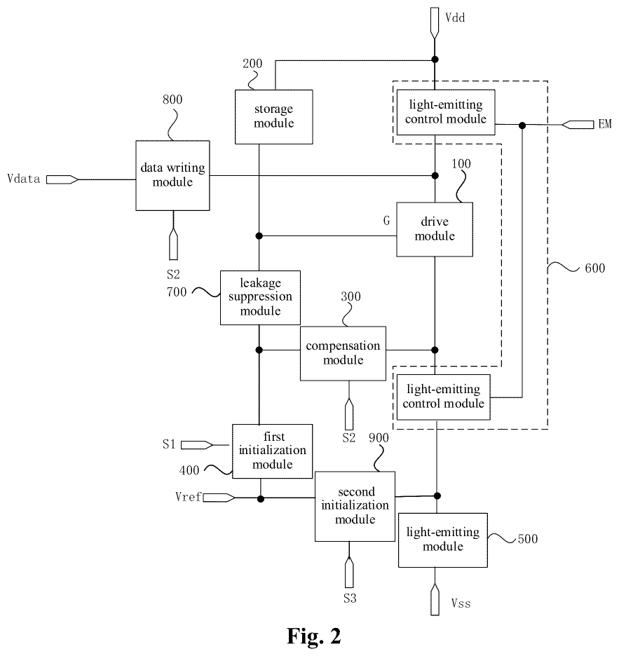

Based on the above reason, an embodiment of the present application provides a pixel circuit. FIG. 2 is a schematic structural diagram of a pixel circuit provided by an embodiment of the present application. Referring to FIG. 2, the pixel circuit includes a drive module 100, a storage module 200, a compensation module 300, a first initialization module 400, a light-emitting module 500, a light-emitting control module 600, a leakage suppression module 700 and a data writing module 800.

The storage module 200 is connected to a control terminal G of the drive module 100, and is configured to store a voltage of the control terminal G of the drive module 100.

The light-emitting control module 600, the drive module 100 and the light-emitting module 500 are connected between a first power line Vdd and a second power line Vss, and the light-emitting control module 600 is configured to control, based on a signal on a light-emitting control signal line EM, the light-emitting module 500 to emit light according to a drive current output by the drive module 100.

A first terminal of the first initialization module 400 is connected to an initialization signal line Vref, a second terminal of the first initialization module 400 is connected to the control terminal G of the drive module 100 through the leakage suppression module 700, and the first initialization module 400 is configured to write an initialization voltage provided by the initialization signal line Vref to the control terminal G of the drive module 100 according to a signal on a first scanning line S1.

A first terminal of the compensation module 300 is connected to a first terminal of the drive module 100, a second terminal of the compensation module 300 is connected to the control terminal G of the drive module 100 through the leakage suppression module 700, and the compensation module 300 is configured to perform threshold compensation for the drive module 100 according to a signal on a second scanning line S2.

The leakage suppression module 700 may be configured to suppress a leakage current at the control terminal G of the drive module 100, and stabilize the potential of the control terminal G of the drive module 100. By reducing the leakage current through the leakage suppression module 700, the leakage suppression module 700 may be configured to suppress the leakage current at the control terminal G of the drive module 100.

The pixel circuit further includes a second initialization module 900, a first terminal of the data writing module 800 is connected to a data signal line Vdata, a second terminal of the data writing module 800 is connected to a second terminal of the drive module 100, a control terminal of the data writing module 800 is connected to the second scanning line S2, and the data writing module 800 is configured to write a data voltage provided by the data signal line Vdata to the drive module 100 according to the signal on the second scanning line S2. That is, the data writing module 800 may be turned on or off according to the signal on the second scanning line S2. Under a condition that the data writing module 800 is turned on, the data voltage provided by the data signal line Vdata can be transmitted to the drive module 100 through the data writing module 800, and then the voltage can be written to the control terminal of the drive module 100 through the transmission path of the drive module 100, the compensation module 300 and the leakage suppression module 700. A first terminal of the second initialization module 900 is connected to the initialization signal line Vref, a second terminal of the second initialization module 900 is connected to a first terminal of the light-emitting module 500, and the second initialization module 900 is configured to write the initialization voltage provided by the initialization signal line Vref to the first terminal of the light-emitting module 500 according to a signal on a third scanning line S3.

As an example, the light-emitting module 500 may be an organic light-emitting diode (OLED), an anode of the OLED is used as the first terminal of the light-emitting module 500, and a cathode of the OLED is used as the second terminal of the light-emitting module 500. The light-emitting module 500 emits light according to the drive current output by the drive module 100, wherein the drive current may be a drive current output by the drive module 100 according to the voltages at the control terminal G and the second terminal thereof.

As an example, the working process of the pixel circuit may include three stages. In a first stage (initialization stage), the signal on the first scanning line S1 controls the first initialization module 400 to turn on, and the initialization voltage provided by the initialization signal line Vref is written to the control terminal of the drive module 100 through the first initialization module 400 and the leakage suppression module 700, thereby realizing the initialization of the control terminal G of the drive module 100 in the first stage. In a second stage (data voltage writing and threshold compensation stage), the signal transmitted by the first scanning line S1 controls the first initialization module 400 to turn off, the signal on the second scanning line S2 controls the data writing module 800 and the compensation module 300 to turn on, and the data voltage provided by the data signal line Vdata is written to the control terminal G of the drive module 100 through the data writing module 800, the drive module 100, the compensation module 300 and the leakage suppression module 100. Since the compensation module 300 can compensate for the threshold value of the drive module 100, the voltage of the control terminal of the drive module 100 includes the voltage associated with the data voltage and the threshold voltage, which realizes the data voltage writing and threshold compensation of the drive module 100. Optionally, the signal of the third scanning line S3 may be the same as the signal of the second scanning line S2. In the second stage, the signal on the third scanning line S3 controls the second initialization module 900 to turn on, and the initialization voltage provided by the initialization signal line Vref is written to the first terminal of the light-emitting module 500 through the second initialization module 900, thereby realizing the initialization of the first terminal of the light-emitting module 500 in the second stage, and avoiding the influence of the residual charge of the first terminal of the light-emitting module 500 on the display effect. In a third stage (light-emitting stage), the signal on the first scanning line S1 controls the first initialization module 400 to turn off, the signal on the second scanning line S2 controls the data writing module 800 and the compensation module 300 to turn off, the signal on the third scanning line S3 controls the second initialization module 900 to turn off, the signal on the light-emitting control signal line EM controls the light-emitting control module 600 to turn on, the light-emitting control module 600 transmits the first power voltage on the first power line Vdd to the second terminal of the drive module 100, and the drive module 100 outputs the drive current to drive the light-emitting module 500 to emit light.

According to this embodiment, the leakage suppression module is disposed between the control terminal of the drive module and the compensation module as well as between the control terminal of the drive module and the first initialization module, thereby suppressing the leakage of the storage module. On one hand, the storage module may have two leakage paths through the compensation module and the first initialization module, that is, due to the existence of the two leakage paths through the compensation module and the first initialization module, the potential at the control terminal of the drive module is not stable. The storage module in this embodiment only leaks current through the leakage suppression module, that is, the control terminal of the drive module only leaks current through the leakage suppression module, that is, there is only one leakage path, which reduces the leakage path and the size of the leakage current, facilitates to maintain the stability of the voltage at the control terminal of the drive module, improves the voltage holding ratio at the control terminal of the drive module, and mitigate the flashing phenomenon caused by the current change of the drive module when the light-emitting module emits light. On the other hand, one terminal of the leakage suppression module is connected to the control terminal of the drive module, and the other terminal of the leakage suppression module is connected to the first terminal of the drive module through the compensation module. Compared with the direct connection between the leakage suppression module and the first terminal of the drive module, the compensation module has a larger resistance. Therefore, in the light-emitting stage, the potential of the other terminal of the leakage suppression module can be avoided from being equal to the potential of the first terminal of the drive module, thereby avoiding a large potential difference between the control terminal of the drive module and the other terminal of the leakage suppression module. Thus, it can be avoided from causing a large leakage current at the control terminal of the drive module through the leakage suppression module, thereby further improving the stability of the potential of the control terminal of the drive module, and further mitigating the flashing problem of the display panel.

For example, the first power line Vdd may be configured to transmit a positive voltage, for example, the voltage transmitted on the first power line Vdd may be +4.6V. The second power line Vss may be configured to transmit a negative voltage, for example, the voltage transmitted on the second power line Vss may be −2.5V. The first scanning line S1 and the second scanning line S2 are configured to transmit the scanning signal, the light-emitting control signal line EM is configured to transmit the light-emission control signal, and the leakage control signal line EMB is configured to transmit the leakage control signal. The scanning signal, the light-emitting control signal and the leakage control signal may be pulse signals, a high level of the scanning signal and the light-emitting control signal may be +7V, and a low level of the scanning signal and the light-emitting control signal may be −7V. The initialization signal line Vref is configured to be transmit a negative voltage. For example, the voltage on the initialization signal line Vref may be −3.5V. The above values are only some examples and are not used to limit the present application.

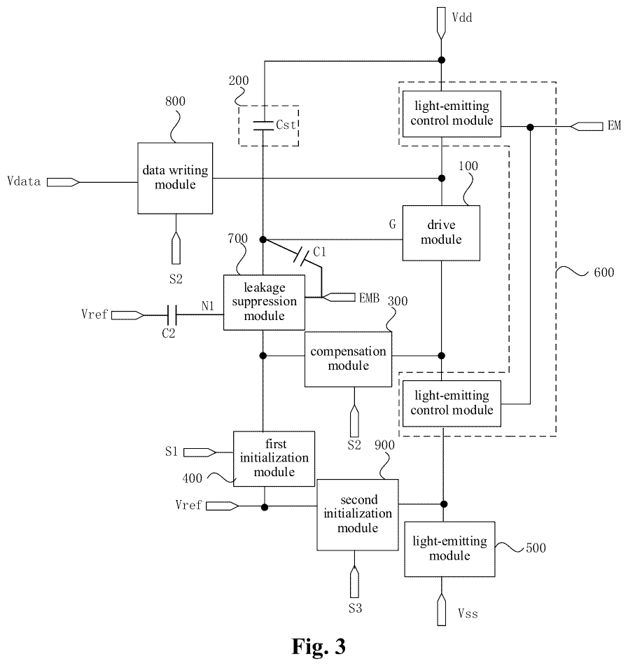

FIG. 3 is a schematic structural diagram of another pixel circuit provided by an embodiment of the present application. As shown in FIG. 3, optionally, at least one node of a node of an internal device of the first initialization module 400, a node of an internal device of the leakage suppression module 700, a node connected to the leakage suppression module 700 and the first initialization module 400, a node connected to the leakage suppression module 700 and the control terminal G of the drive module 100, and a node connected to the leakage suppression module 700 and the compensation module 300 is connected with a capacitor. The capacitor is configured as a voltage stabilization capacitor. That is, the voltage stabilization capacitor is a capacitor configured to stabilize the voltage of the control terminal G of the drive module 100.

For example, in some embodiments, a first electrode of the capacitor is connected to one node of the node of the internal device of the first initialization module 400, the node of the internal device of the leakage suppression module 700, the node connected to the leakage suppression module 700 and the first initialization module, the node connected to the leakage suppression module 700 and the control terminal G of the drive module 100, and the node connected to the leakage suppression module and the compensation module 300, and a second electrode of the capacitor is connected to a signal line. In some embodiments, the signal line may be a constant voltage signal line or a pulse signal line.

For example, in some embodiments, the constant voltage signal line includes the initialization signal line Vref or the first power line Vdd, and the pulse signal line includes the leakage control signal line EMB.

For example, in some embodiments, the pixel circuit includes two voltage stabilization capacitor: a first voltage stabilization capacitor C1 and a second voltage stabilization capacitor C2. The control terminal of the leakage suppression module 700 is connected to the leakage control signal line EMB. One terminal of the first voltage stabilization capacitor C1 is connected to the control terminal G of the drive module 100, and another terminal of the first voltage stabilization capacitor C1 is connected to the leakage control signal line EMB. One terminal of the second voltage stabilization capacitor C2 is connected to the node N1 of the internal device of the leakage suppression module 700, and another terminal of the second voltage stabilization capacitor C2 is connected to the initialization signal line Vref. The leakage suppression module 700 may include a transistor, the transistor may include a double-gate transistor. The double-gate transistor may include two sub-transistors connected in series, the gates of the two sub-transistors connected in series are connected to a same signal line. The node N1 of the internal device of the leakage suppression module 700 may be a double-gate node of the double-gate transistor, and the double-gate node may be a connection node between the two sub-transistors connected in series in the double-gate transistor.

The first voltage stabilization capacitor C1 may stabilize the voltage at the control terminal G of the drive module 100, so that the voltage of the control terminal G is not susceptible to other signal jumps, and the second voltage stabilization capacitor C2 may stabilize the voltage at the node N1 of the internal device of the leakage suppression module 700, so that the voltage at the node N1 of the internal device of the leakage suppression module 700 is not susceptible to other signal jumps. Under a condition that the leakage suppression module 700 is turned on, the voltage of the control terminal G of the drive module 100 is equal to the voltage at the node N1 of the internal device of the leakage suppression module 700. After the leakage suppression module 700 is turned off, the first voltage stabilization capacitor C1 and the second voltage stabilization capacitor C2 maintain the voltage of the control terminal G and the voltage at the node N1 of the internal device of the leakage suppression module 700, so that the voltage of the control terminal G and the voltage at the node N1 remain unchanged or change relatively little. Thus, after the leakage suppression module 700 is turned off, the voltage of the control terminal G and the voltage at the node N1 of the internal device of the leakage suppression module 700 are still equal or the voltage difference is small. The smaller the voltage difference between the control terminal G of the drive module 100 and the node N1 of the internal device of the leakage suppression module 700, the smaller the leakage current passing through the leakage suppression module 700. Then, by setting the first voltage stabilization capacitor C1 and the second voltage stabilization capacitor C2, the stability of the voltage of the control terminal G of the drive module 100 may be maintained, the voltage holding ratio at the control terminal of the drive module may be improved, the flashing phenomenon when the light-emitting module 500 emits light may be mitigated, and the display quality may be improved.

Referring further to FIG. 3, optionally, the storage module 200 includes a storage capacitor Cst, and capacitance values of the voltage stabilization capacitors C1 and C2 are less than a capacitance value of the storage capacitor Cst.

The voltage stabilization capacitor is different from the storage capacitor Cst, and the storage capacitor Cst needs to store the voltage of the control terminal G of the drive module 100. Thus, the capacitance value of the storage capacitor Cst is large. The voltage stabilization capacitor is configured to stabilize the voltage at the node connected the voltage stabilization capacitor and/or stabilize the voltage of the control terminal G of the drive module 100, thereby reducing the size of the leakage current. Therefore, the capacitance value of the voltage stabilization capacitor may be small, and thus may be smaller than the capacitance value of the storage capacitor Cst. Because that the capacitance value of the voltage stabilization capacitor is small, the area of the two plates of the capacitor may be small, and the layout of the voltage stabilization capacitor in the circuit may be simple.

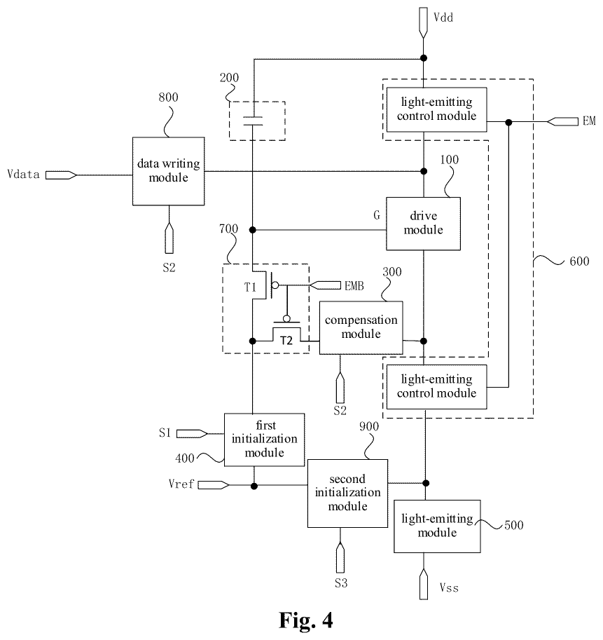

Referring to FIG. 4, optionally, the leakage suppression module 700 includes a first transistor T1 and a second transistor T2;
a first electrode of the first transistor T1 is connected to the control terminal G of the drive module 100, and a second electrode of the first transistor T1 is connected to the second terminal of the first initialization module 400;
a first electrode of the second transistor T2 is connected to the second electrode of the first transistor T1, and a second electrode of the second transistor T2 is connected to the second terminal of the compensation module 300;
a gate of the first transistor T1 and a gate of the second transistor T2 are connected to a leakage control signal line EMB.

As an example, the first transistor T1 and the second transistor T2 are both P-type transistors. Under a condition that the signal of the leakage control signal line EMB is at high level, the first transistor T1 and the second transistor T2 are turned off, and under a condition that the signal of the leakage control signal line EMB is at low level, the first transistor T1 and the second transistor T2 are turned on. In the first stage of the working process of the pixel circuit, the leakage control signal line EMB is at low level, the first transistor T1 and the second transistor T2 are turned on, and the initialization voltage on the initialization signal line Vref is written to the control terminal G of the drive module 100 through the first initialization module 400 and the first transistor T1, thereby realizing the initialization of the drive module 100. In the second stage, the data voltage on the data signal line Vdata is written to the control terminal of the drive module 100 through the data writing module 800, the drive module 100, the compensation module 300, the second transistor T2 and the first transistor T1, thereby realizing the data voltage writing and threshold compensation.

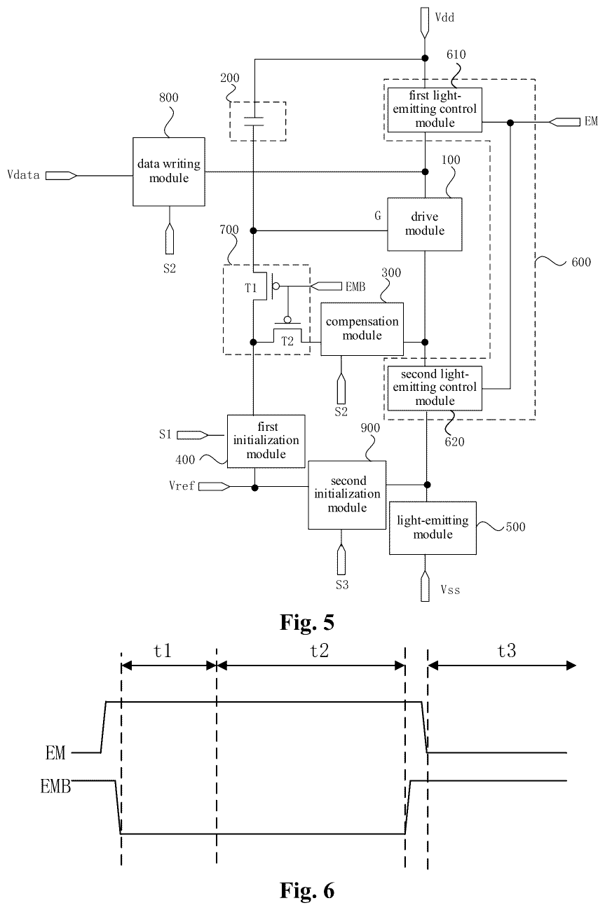

In the pixel circuit of this embodiment, there is only one leakage path, the first transistor T1, at the control terminal G of drive module 100. By contrast, in the pixel circuit in FIG. 1, there are two leakage paths, the second switch transistor M2 and the fifth switch transistor M5. Therefore, in the pixel circuit of this embodiment, the leakage path is reduced, and the size of the leakage current is reduced. Further, the amplitude of the voltage change of the control terminal G of the drive module 100 is reduced, and the voltage of the control terminal G of the drive module 100 is relatively stable, thereby reducing the attenuation of the brightness of the light-emitting module 500 in a frame, mitigating the flashing phenomenon of the light-emitting module 500, and improving the display quality. Referring to FIG. 5, as an example, the light-emitting control module 600 may include a first light-emitting control module 610 and a second light-emitting control module 620.

The first light-emitting control module 610 is connected between the first power line Vdd and the second terminal of the drive module 100, the second light-emitting control module 620 is connected between the first terminal of the drive module 100 and the first terminal of the light-emitting module 500, the second terminal of the light-emitting module 500 is connected to the second power line Vss, and a control terminal of the first light-emitting control module 610 and a control terminal of the second light-emitting control module 620 are connected to the light-emitting control signal line EM.

In the first stage and the second stage of the working process of the pixel circuit, the first light-emitting control module 610 and the second light-emitting control module 620 are turned off under the control of the light-emitting control signal line EM. In the third stage, the first light-emitting control module 610 and the second light-emitting control module 620 are turned on under the control of the light-emitting control signal line EM, and the first power voltage provided by the first power line Vdd is written to the second terminal of the drive module 100 through the first light-emitting control module 610, and the drive module 100 drives the light-emitting module 500 to emit light according to the voltage of the control terminal G and the voltage of the second terminal of the drive module 100.

Referring to FIGS. 5 and 6, the timing diagram shown in FIG. 6 may be applied to the pixel circuit shown in FIG. 5. As an example, within a frame, a time interval of a pulse of a signal on the leakage control signal line EMB is within a time interval of a pulse of a signal on the light-emitting control signal line EM.

As an example, the leakage suppression module 700 is turned on under a condition that the signal on the leakage control signal line EMB is at low level, and the leakage suppression module 700 is turned off under a condition that the signal on the leakage control signal line EMB is at high level. The light-emitting control module 600 is turned on under a condition that the signal on the light-emitting control signal line EM is at low level, and the light-emitting control module 600 is turned off under a condition that the signal on the light-emitting control signal line EM is at high level. In the first stage t1 and the second stage t2, the signal on the light-emitting control signal line EM is at high level, the light-emitting control module 600 is turned off, and the signal on the leakage control signal line EMB is at low level, the leakage suppression module 700 is turned on, so that the initialization voltage is written to the control terminal G of the drive module 100 through the leakage suppression module 700 in the first stage t1, and the data voltage is written to the control terminal G of the drive module 100 through the leakage suppression module 700 in the second stage t2. The turned on time interval of the leakage suppression module 700 is within the turned off time interval of the light-emitting control module 600, so that in the first stage t1 and the second stage t2 where the leakage control module 700 is turned on, the light-emitting control module 600 is turned off. Therefore, it can avoid the light-emitting control module 600 from being turned on in the first stage t1 and the second stage t2, which otherwise may turn on the light-emitting module 500 under a condition that the control terminal G of the drive module 100 has not completed initialization or data writing and threshold compensation, thereby causing the light-emitting module 500 to emit light and affecting the display quality. Therefore, the time interval of the pulse of the signal on the leakage control signal line EMB being within the time interval of the pulse of the signal on the light-emitting control signal line EM may ensure that the light-emitting module 500 emits light after the drive module has completed the initialization, the data writing and threshold compensation, which is beneficial to improve the display quality.

Referring further to FIGS. 5 and 6, as an example, the signal on the leakage control signal line EMB and the signal on the light-emitting control signal line EM may be inverted to each other. For example, the time interval of the pulse of the signal on the leakage control signal line EMB may be less than or equal to the time interval of the pulse of the signal on the light-emitting control signal line EM.

As an example, the leakage suppression module 700 and the light-emitting control module 600 are both P-type transistors. In the first stage t1, the signal on the leakage control signal line EMB is at low level, the signal on the light-emitting control signal line EM is at high level, the leakage suppression module 700 is turned on, the light-emitting control module 600 is turned off, and the initialization voltage on the initialization signal line Vref is written to the control terminal G of the drive module 100 through the leakage suppression module 700. In the second stage t2, the signal on the leakage control signal line EMB is at low level, the signal on the light-emitting control signal line EM is at high level, the leakage suppression module 700 is turned on, the light-emitting control module 600 is turned off, and the data voltage on the data signal line Vdata is written to the control terminal G of the drive module 100 through the leakage suppression module 700. In the third stage t3, the signal on the leakage control signal line EMB is at high level, the signal on the light-emitting control signal line EM is at low level, the leakage suppression module 700 is turned off, the light-emitting control module 600 is turned on, the first power voltage on the first power line Vdd line is transmitted to the second terminal of the drive module 100 through the first light-emitting control module 610, and the drive module 100 drives the light-emitting module 500 to emit light according to the voltage of the control terminal G and the voltage of the second terminal of the drive module 100. The light-emitting control signal line EM is usually connected to light-emitting control drive circuits located in the left and right border areas of the display panel, and the light-emitting control drive circuit may be composed of a cascaded shift register. The signal on the leakage control signal line EMB and the signal on the light-emitting control signal line EM are inverted to each other. It is only required to set an inverter at the output terminal of the light-emitting control drive circuit, and the signal output by the light-emitting control drive circuit may be inverted by the inverter and then output to the leakage control signal line EMB. Therefore, it is no longer necessary to design a scanning circuit composed of a complex shift register for the leakage control signal line EMB, which can reduce the circuit devices in the border area of the display panel, and realize the narrow border design of the display panel easily.

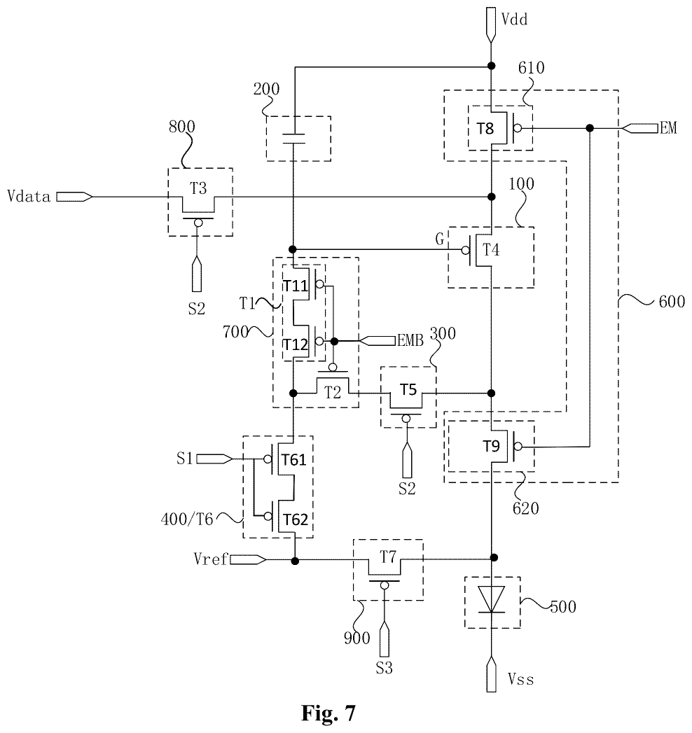

FIG. 7 is a schematic structural diagram of another pixel circuit provided by an embodiment of the present application. referring to FIG. 7, as an example, the pixel circuit may further include a data writing module 800 and a second initialization module 900. The data writing module 800 includes a third transistor T3, the drive module 100 includes a fourth transistor T4; the compensation module 300 includes a fifth transistor T5, the first initialization module 400 includes a sixth transistor T6; the second initialization module 900 includes a seventh transistor T7; the first light-emitting control module 610 includes an eighth transistor T8, and the second light-emitting control module 620 includes a ninth transistor T9.

A first electrode of the third transistor T3 is connected to the data signal line Vdata, a second electrode of the third transistor T3 is connected to the second terminal of the drive module 100, and a gate of the third transistor T3 is connected to the second scanning line S2.

A first electrode of the fourth transistor T4 is used as the second terminal of the drive module 100, a second electrode of the fourth transistor T4 is used as the first terminal of the drive module 100, and a gate of the fourth transistor T4 is used as the control terminal G of the drive module 100.

A first electrode of the fifth transistor T5 is used as the first terminal of the compensation module 300, a second electrode of the fifth transistor T5 is used as the second terminal of the compensation module 300, and a gate of the fifth transistor T5 is connected to the second scanning line S2.

A first electrode of the sixth transistor T6 is used as the first terminal of the first initialization module 400, a second electrode of the sixth transistor T6 is used as the second terminal of the first initialization module 400, and a gate of the sixth transistor T6 is connected to the first scanning line S1.

A first electrode of the seventh transistor T7 is connected to the initialization signal line Vref, a second electrode of the seventh transistor T7 is connected to the first terminal of the light-emitting module 500, and a gate of the seventh transistor T7 is connected to a third scanning line S3.

A first electrode of the eighth transistor T8 is connected to the first power line Vdd, a second electrode of the eighth transistor T8 is connected to the first electrode of the fourth transistor T4, and a gate of the eighth transistor T8 is connected to the light-emitting control signal line EM.

A first electrode of the ninth transistor T9 is connected to the second electrode of the fourth transistor T4, a second electrode of the ninth transistor T9 is connected to the first terminal of the light-emitting module 500, and a gate of the ninth transistor T9 is connected to the light-emitting control signal line EM.

At least one of the first transistor T1 and the sixth transistor T6 includes a double-gate transistor.

Specifically, the first transistor T1 includes a sub-transistor T11 and a sub-transistor T12, and the sixth transistor T6 includes a sub-transistor T61 and a sub-transistor T62. The first transistor T1, the second transistor T2, the third transistor T3, the fourth transistor T4, the fifth transistor T5, the sixth transistor T6, the seventh transistor T7, the eighth transistor T8 and the ninth transistor T9 may be P-type transistors, and may be N-type transistors, which is not limited by this embodiment. For example, the description takes above transistors being the P-type transistors as an example.

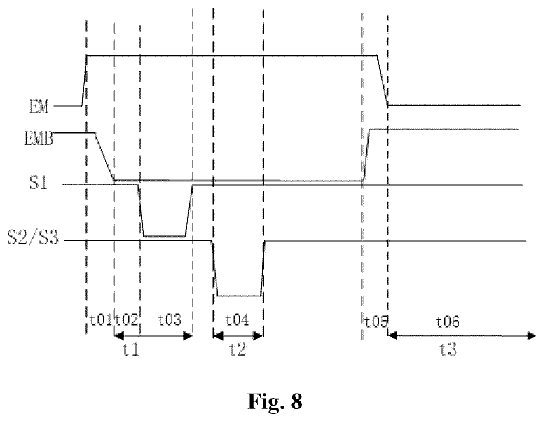

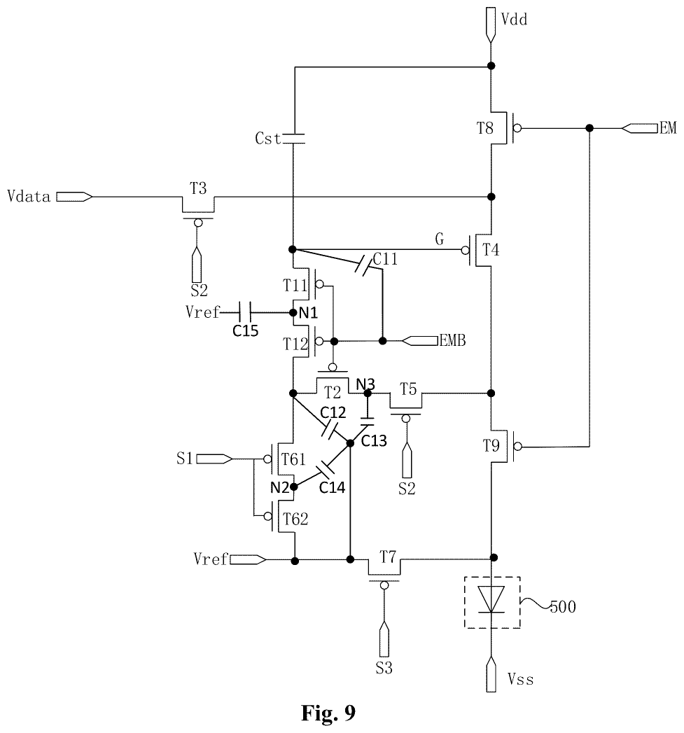

FIG. 8 is a timing diagram of a pixel circuit provided by an embodiment of the present application. The timing diagram shown in FIG. 8 may be applied to the pixel circuit of FIG. 7, for example, the third scanning line S3 and the second scanning line S2 are the same signal. Referring to FIGS. 8 and 9, the first stage t1 includes a second sub-stage t02 and a third sub-stage t03, the second stage t2 includes a fourth sub-stage t04, and the third stage t3 includes a sixth sub-stage t06.

In the first sub-stage t01, the signal on the light-emitting control signal line EM is raised and is at high level, and the eighth transistor T8 and the ninth transistor T9 are turned off. In the second sub-stage t02, the signal on the leakage control signal line EMB is reduced and is at low level, and the first transistor T1 and the second transistor T2 are turned on. In the third sub-stage t03, the signal on the first scanning line S1 is at low level, and the sixth transistor T6 is turned on. In the third sub-stage t03, the initialization voltage provided by the initialization signal line Vref is transmitted to the gate of the fourth transistor T4 through the sixth transistor T6 and the first transistor T1, so that the gate of the fourth transistor T4 is reset. After the reset is completed, the signal on the first scanning line S1 is raised and is at high level, and the sixth transistor T6 is turned off. In the first stage t1, the signal on the light-emitting control signal line EM and the signal on the second scanning line S2 are at high level, and the third transistor T3, the fifth transistor T5, the seventh transistor T7, the eighth transistor T8 and the ninth transistor T9 are turned off.

In the fourth sub-stage t04, the signal on the second scanning line S2 is at low level, and the third transistor T3 and the fifth transistor T5 are turned on. The signal on the leakage control signal line EMB is at low level, and the first transistor T1 and the second transistor T2 are turned on. The data voltage on the data signal line Vdata is written to the gate of the fourth transistor T4 through the third transistor T3, the fourth transistor T4, the fifth transistor T5, the second transistor T2 and the first transistor T1, thereby achieving the writing of the data voltage to the gate of the fourth transistor T4 and the compensation of the threshold voltage of the fourth transistor T4. Further, in the fourth sub-stage t04, the signal on the third scanning line S3 is the same as the signal on the second scanning line S2 and is at low level, the seventh transistor T7 is turned on, and the initialization voltage provided by the initialization signal line Vref is transmitted to the first terminal of the light-emitting module 500 through the seventh transistor T7, thereby resetting the first terminal of the light-emitting module 500, and avoiding the influence of the residual charge of the first terminal of the light-emitting module 500 on the display effect.

In the fifth sub-stage t05, the signal on the leakage control signal line EMB is raised and is at high level, and the first transistor T1 and the second transistor T2 are turned off. In the sixth sub-stage t06, the signal on the first scanning line S1 and the signal on the second scanning line S2 are at high level, the third transistors T3, the fifth transistor T5, the sixth transistor T6 and the seventh transistor T7 are turned off. Further, the signal on the light-emitting control signal line EM is at low level, the eighth transistor T8 and the ninth transistor T9 are turned on. Thus, the first power voltage on the first power line Vdd is transmitted to the first electrode of the fourth transistor T4 through the eighth transistor T8, and the fourth transistor T4 drives the light-emitting module 500 to emit light according to the voltage of the gate and the voltage of the first electrode of the fourth transistor T4.

FIG. 9 is a schematic structural diagram of another pixel circuit provided by an embodiment of the present application. Referring to FIG. 9, as an example, the pixel circuit further includes a first capacitor C11, a second capacitor C12, a third capacitor C13, a fourth capacitor C14 and a fifth capacitor C15.

A first terminal of the first capacitor C11 is connected to the gate of the fourth transistor T4, and a second terminal of the first capacitor C11 is connected to the leakage control signal line EMB. A first terminal of the second capacitor C12 is connected to the second electrode of the sixth transistor T6, and a second terminal of the second capacitor C12 is connected to the initialization signal line Vref. A first terminal of the third capacitor C13 is connected to the second electrode N3 of the second transistor T2, and a second terminal of the third capacitor C13 is connected to the initialization signal line Vref. A first terminal of the fourth capacitor C14 is connected to a double-gate node N2 of the sixth transistor T6, and a second terminal of the fourth capacitor C14 is connected to the initialization signal line Vref. A first terminal of the fifth capacitor C15 is connected to the initialization signal line Vref, and a second terminal of the fifth capacitor C15 is connected to a double-gate node N1 of the first transistor T1.

In the light-emitting stage, by adjusting the size of the third capacitor C13 and the size of the fourth capacitor C14, the voltage of the second electrode of the second transistor T2 (i.e., the third node N3) is greater than the voltage of the first electrode of the second transistor T2, and the voltage of the first electrode of the second transistor T2 is greater than the voltage of the double-gate node N2 of the sixth transistor T6. Thus, the second electrode of the second transistor T2 charges the first electrode of the second transistor T2, and the first electrode of the second transistor T2 leaks electricity to the double-gate node N2 of the sixth transistor T6, which realizes that the charging process and the leakage process of the first electrode of the second transistor T2 are complementary to each other, thereby balancing the potential of the first electrode of the second transistor T2, and reducing the leakage of the first electrode of the second transistor T2. Therefore, the voltage holding ratio at the control terminal G of the drive module 100 in the pixel circuit may be improved, the flashing phenomenon of the light-emitting module 500 when driving by low frequency may be mitigated, and the display quality may be improved.

The first capacitor C11, the second capacitor C12 and the fifth capacitor C15 may stabilize the voltage of the gate of the fourth transistor T4, the voltage of the double-gate node N1 of the first transistor T1, and the voltage of the first electrode of the second transistor T2. Under a condition that the first transistor T1 and the second transistor T2 are turned on, the voltage of the gate of the fourth transistor T4, the voltage of the double-gate node N1 of the first transistor T1, and the voltage of the first electrode of the second transistor T2 are equal. Thus, in the light-emitting stage, after the first transistor T1 and second transistor T2 are turned off, the first capacitor C11, the second capacitor C12 and the fifth capacitor C15 may maintain the voltage of the gate of the fourth transistor T4, the voltage of the double-gate node N1 of the first transistor T1, and the voltage of the first electrode of the second transistor T2, which causes that the voltage of the gate of the fourth transistor T4, the voltage of the double-gate node N1 of the first transistor T1, and the voltage of the first electrode of the second transistor T2 are equal, thereby reducing the leakage of the first transistor T1, reducing the leakage current through the first transistor T1, and maintaining the voltage at the gate of the fourth transistor T4. Therefore, the voltage holding ratio at the control terminal G of the drive module 100 in the pixel circuit may be improved, the flashing phenomenon of the light-emitting module 500 when driving by low frequency may be mitigated, and the display quality may be improved.

As an example, a capacitance value of the second capacitor C12 is 10 fF to 60 fF, and a capacitance value of the fifth capacitor C15 is 10 fF to 60 fF.

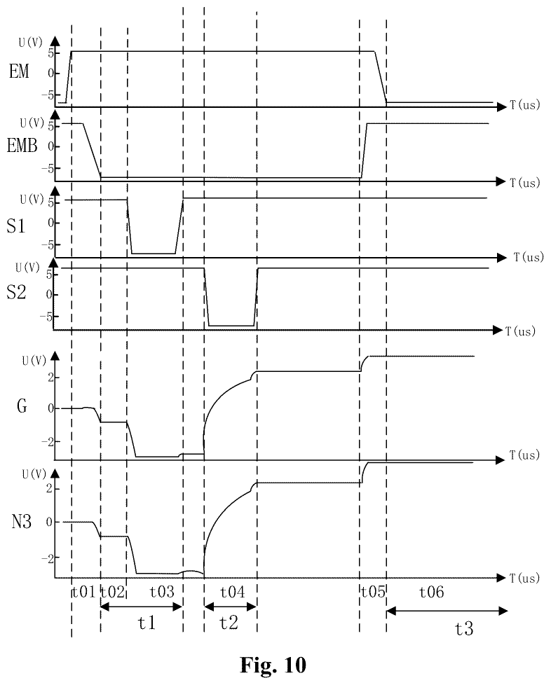

FIG. 10 is a simulated signal waveform diagram provided by an embodiment of the present application. FIG. 10 is a corresponding waveform diagram when the pixel circuit shown in FIG. 9 is working. As shown in FIG. 10, in the sixth sub-stage t06, that is, in the light-emitting stage, the voltage of the control terminal G of the drive module 100 (the gate of the fourth transistor T4) and the voltage of the second electrode N3 of the second transistor T2 are maintained in a stable state. Thus, it is illustrated that the first capacitor C11, the second capacitor C12, the third capacitor C13, the fourth capacitor C14 and the fifth capacitor C15 can maintain the stability of the voltage at the gate of the fourth transistor T4. Therefore, the voltage holding ratio at the control terminal G of the drive module 100 in the pixel circuit may be improved, the flashing phenomenon of the light-emitting module 500 when driving by low frequency may be mitigated, and the display quality may be improved.

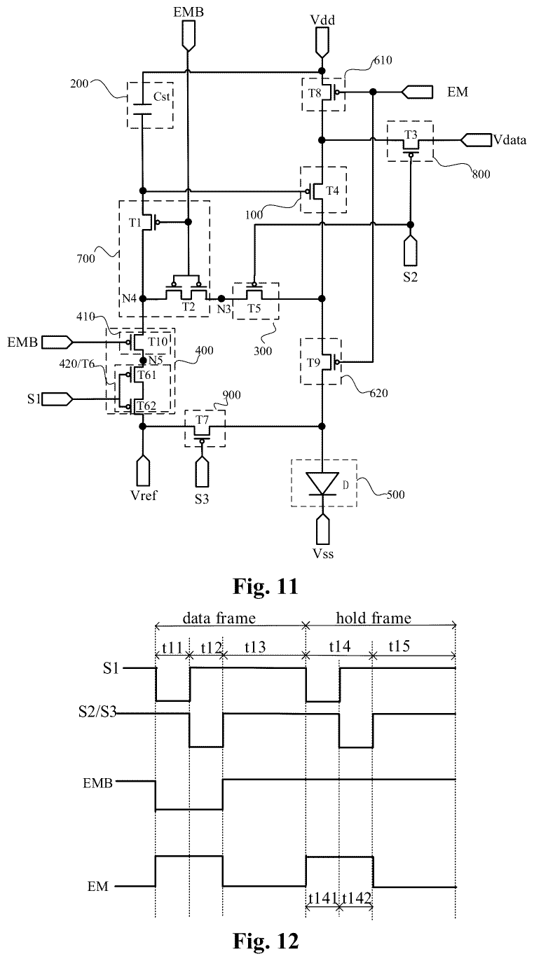

As shown in FIG. 11, in the pixel circuit provided by the embodiment of the present application, the first initialization module 400 may include a first submodule 410 and a second submodule 420. The first submodule 410 is connected between the second submodule 420 and the second electrode of the first transistor T1, and the second submodule 420 is connected between the first submodule 410 and the initialization signal line Vref. For example, the first submodule 410 is connected to the second electrode of the first transistor T1 at a fourth node N4, and the first submodule 410 is connected to the second submodule 420 at a fifth node N5.

The pixel circuit may support a low-frequency mode. In order to reduce the power consumption, as shown in FIG. 12, the working process of the pixel circuit can be configured to include a data frame and a hold frame. For example, one data frame can be followed by one or more hold frames. In a high-frequency mode, the working process of the pixel circuit in the display panel may include only the data frame.

As an example, in the high-frequency mode and the low-frequency mode, the frequencies of the scanning signal may be the same. Thus, even if the display panel is displayed in the low-frequency mode, it can also give the user the visual effect of the high-frequency mode. In the low-frequency mode, as shown in FIG. 12, the signal applied on the first scanning line S1 may be the same in the data frame and the hold frame, and the signal applied on the second scanning line S2 may be the same in the data frame and the hold frame.

Referring further to FIG. 12, the data frame may include an initialization stage t11. For example, the functional modules of the pixel circuit are turned on at the low level and are turned off at the high level. In the initialization stage t11, the first submodule 410 may be turned on under the control of the low level of the leakage control signal line EMB, and the second submodule 420 may be turned on under the control of the low level of the first scanning line S1; in the hold frame, the signal on the leakage control signal line EMB may always be at high level, and the first submodule 410 may always be turned off.

As an example, in the data frame, the data signal can be transmitted to the control terminal of the drive module 100, and in the hold frame, the data signal cannot be transmitted to the control terminal of the drive module. The first terminal of the light-emitting module 500 may be initialized at the hold frame, thereby mitigating the flashing. For example, in the hold frame, the second initialization module 900 may be turned on for a period of time under the control of the signal of the third scanning line S3, thereby transmitting the signal of the initialization signal line Vref to the first terminal of the light-emitting module 500, and then initializing the first terminal of the light-emitting module 500. In FIG. 12, the signal of the third scanning line S3 is the same as the signal of the second scanning line S2.

The inventor found that the second submodule 420 and the second initialization module 900 can be turned on or off under the control of the scanning signal. For example, the second submodule 420 and the second initialization module 900 can be turned on or off under the control of the scanning signal generated by the gate drive circuit of the display panel. The second submodule 420 may also be turned on for a period of time in the hold frame, and the signal of the initialization signal line Vref may be transmitted to the fifth node N5 in the hold frame. If the first submodule 410 is not disposed, the signal of the initialization signal line Vref is transmitted directly to the fourth node N4 in the hold frame. As an example, the signal of the initialization signal line Vref is a constant negative voltage, and the potential of the control terminal G of the drive module 100 in the hold frame is a positive potential. Thus, the difference between the potential of the control terminal G of the drive module 100 and the potential of the fourth node N4 in the hold frame is large. That is, the potential difference between the two terminals of the leakage suppression module 700 is large, thereby causing the increasing of the leakage current through the leakage suppression module 700, causing the instability of the potential of the control terminal of the drive module 100 in the hold frame, and causing the flashing problem. In the embodiment of the present application, by setting the first submodule 410 and turning off the first submodule 410 in the hold frame, the signal of the initialization signal line Vref can be avoided from being directly transmitted to the fourth node N4 in the hold frame, thereby avoiding the potential difference between the two terminals of the leakage suppression module 700 being large, reducing the leakage current of the leakage suppression module 700. Therefore, the potential of the control terminal of the drive module is stabilized, and the flashing problem is avoided.

As shown in FIG. 12, the data frame may also include a data writing stage t12. In the data writing stage t12, the second transistor T2 may be turned on under the control of the low level of the leakage control signal line EMB, and the compensation module 300 may be turned on under the control of the low level of the second scanning line S2. In the hold frame, the leakage control signal line EMB may always be at high level, so that the second transistor T2 may always be turned off under the control of the high level of the leakage control signal line EMB.

The inventor also found that, as shown in FIG. 11, the compensation module 300 can be turned on or off under the control of the scanning signal, for example, the compensation module 300 can be turned on or off under the control of the scanning signal generated by the gate drive circuit of the display panel. The compensation module 300 may also be turned on for a period of time in the hold frame. The pixel circuits of a same column can be connected to a same data signal line, and the data signals required by other pixel circuits of the same column may be transmitted to the third nodes N3 of the pixel circuits in the hold frame. As shown in FIG. 11, the data signal is transmitted to the third node N3 through the drive module 100 and the compensation module 300 in the hold frame. Under a condition that the second transistor T2 is not provided, the data signals required by other pixel circuits may be transmitted to the fourth point N4 directly through the data writing module 800, the drive module 100 and the compensation module 300 in the hold frame. The data signals required by the pixel circuits of the same column in the same frame are quite different, such that the difference between the potential of the control terminal G of the drive module 100 and the potential of the fourth node N4 is large in the hold frame. That is, the potential difference between the two terminals of the first transistor T1 of the leakage suppression module 700 is large, thereby causing the increasing of the leakage current through the first transistor T1 of the leakage suppression module 700, causing the instability of the potential of the control terminal of the drive module 100 in the hold frame, and causing the flashing problem. In the embodiment of the present application, by setting the second transistor T2 and turning off the second transistor T2 in the hold frame, the data signals required by other pixel circuits can be avoided from being transmitted to the fourth node N4 in the hold frame, so that the difference between the potential of the control terminal of the drive module and the potential of the fourth point N4 is small in the hold frame, thereby further stabilizing the potential of the control terminal of the drive module, and avoiding the flashing problem.

As shown in FIG. 11, the second submodule 420 may include a sixth transistor T6, and the first submodule 410 may include a tenth transistor T10. A first electrode of the sixth transistor T6 is used as the first terminal of the first initialization module 400, a second electrode of the sixth transistor T6 is connected to a first electrode of the tenth transistor T10, a second electrode of the tenth transistor T10 is connected to the second electrode of the first transistor T1, a gate of the sixth transistor T6 is connected to the first scanning line S1, and a gate of the tenth transistor T10 is connected to the leakage control signal line EMB.

For example, the second transistor T2 is a double-gate transistor. So, the electrical connection between the leakage suppression module 700 and the tenth transistor T10 can be realized without arranging additional holes and metal wires in the layout design (this will be introduced below), which is equivalent to reduce the number of the holes and the number of the metal wires in the layout design, thereby improving the space utilization rate, and facilitating the formation of high-resolution display panels.

Moreover, the specific structures of other functional modules of the pixel circuit shown in FIG. 11 may be the same as that described in the above embodiments, which will not be described in detail here.

In combination with reference to FIGS. 11 and 12, the following working process is shown under a condition that the modules of the pixel circuit 10 are turned on at low level and are turned off at high level. The data frame may include an initialization stage t11, a data writing stage t12 and a light-emitting stage t13, and the hold frame may include a non-light-emitting stage t14 and a light-emitting stage t15. The non-light-emitting stage t14 may include a first stage t141 and a second stage t142.

In the initialization stage t11, the signal on the light-emitting control signal line EM and the signal on the second scanning line S2 are at high level, the signal on the leakage control signal line EMB and the signal on the first scanning line S1 are at low level, the sixth transistor T6, the tenth transistor T10 and the first transistor T1 are turned on, and the signal on the initialization signal line Vref is transmitted to the gate of the fourth transistor T4, thereby initializing the gate of the fourth transistor T4. Since the storage capacitor Cst is electrically connected to the gate of the fourth transistor T4, the storage capacitor Cst is also initialized in the initialization stage. Also, in the initialization stage t11, the second transistor T2 is turned on, and the third transistor T3, the fifth transistor T5, the eighth transistor T8 and the ninth transistor T9 are turned off.

In the data writing stage t12, the signal on the light-emitting control signal line EM and the signal on the first scanning line S1 are at high level, the signal on the leakage control signal line EMB and the signal on the second scanning line S2 are at low level, the first transistor T1, the second transistor T2, the third transistor T3 and the fifth transistor T5 are turned on. The data signal of the data signal line Vdata is written to the gate of the fourth transistor T4 through the third transistor T3, the fourth transistor T4, the fifth transistor T5, the second transistor T2 and the first transistor T1, and threshold compensation is performed for the threshold voltage of the fourth transistor T4. Further, the signal on the third scanning line S3 may be the same as the signal on the second scanning line S2. In the data writing stage t12, the seventh transistor T7 is turned on, and the signal on the initialization signal line Vref is transmitted to a first terminal of a light-emitting element D, thereby initializing the first terminal of the light-emitting element D. In addition, in the data writing stage t12, the sixth transistor T6, the eighth transistor T8, and the ninth transistor T9 are turned off.

In the light-emitting stage t13 of the data frame and the light-emitting stage t15 of the hold frame, the signal on the light-emitting control signal line EM is at low level, the signal on the leakage control signal line EMB, the signal on the first scanning line S1 and the signal on the second scanning line S2 are at high level, the eighth transistor T8 and the ninth transistor T9 are turned on, and the drive current generated by the fourth transistor T4 is transmitted to the light-emitting diode D. Thus, the light-emitting diode D starts to emit light.

In the first stage t141, the signal on the light-emitting control signal line EM, the signal on the leakage control signal line EMB and the signal on the second scanning line S2 are at high level, and the signal on the first scanning line S1 is at low level. The sixth transistor T6 is turned on, the signal on the initialization signal line Vref is transmitted to the fifth node N5. Further, the tenth transistor T10 is turned off, and the signal on the initialization signal line Vref is not transmitted to the fourth node N4.

In the second stage t142, the signal on the light-emitting control signal line EM, the signal on the leakage control signal line EMB and the signal on the first scanning line S1 are at high level, and the signal on the second scanning line S2 and the signal on the third scanning line S3 are at low level. The seventh transistor T7 is turned on, the signal on the initialization signal line Vref is transmitted to the first terminal of the light-emitting element D, and the first terminal of the light-emitting element D is initialized. The fifth transistor T5 and the third transistor T3 are turned on, and the signal of the data signal line Vdata is transmitted to the third node N3. Because that the second transistor T2 is turned off, the signal of the data signal line Vdata is not transmitted to the fourth node N4.

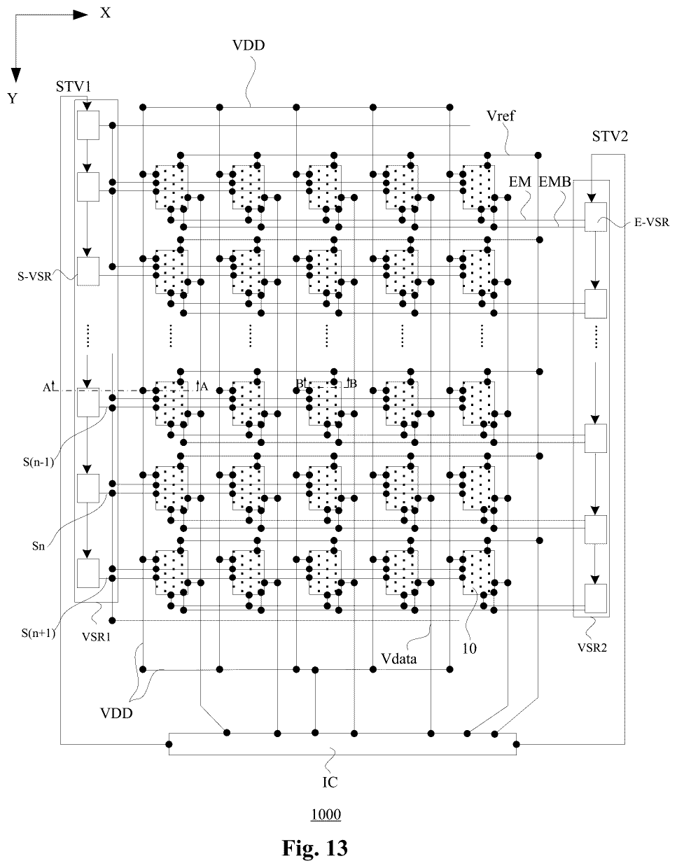

Based on a same inventive concept, the present application also provides a display panel. As shown in FIG. 13, the embodiment of the present application provides a display panel 1000 including one or more pixel circuits 10. A plurality of pixel circuits 10 may be distributed in an array, for example, the plurality of pixel circuits 10 may be distributed in an array along a first direction X and a second direction Y intersected with each other. For example, the first direction X may be a row direction, and the second direction Y may be a column direction. Of course, the first direction X may also be a column direction, and the second direction Y may also be a row direction.

As an example, the display panel and the display device provided by the embodiments of the present application may support a low-frequency mode and a high-frequency mode. For example, the low-frequency mode may include a refresh rate less than 60 Hz, such as 30 Hz, 15 Hz, etc. The high-frequency mode may include a refresh rate greater than or equal to 60 Hz, such as 60 Hz, 90 Hz, 120 Hz, 144 Hz, etc.

In some alternative embodiments, as shown in FIG. 13, the display panel 1000 may include a shift register VSR2, and the shift register VSR2 may include light-emitting control circuits E-VSR that are multistage cascaded. In the following examples, under a condition that the signal on the light-emitting control signal line EM and the signal on the leakage control signal line EMB are inverted signals, the light-emitting control signal line EM and the leakage control signal line EMB connected to a same row of the pixel circuits may be electrically connected to a same light-emitting control circuit E-VSR. That is, the same light-emitting control circuit E-VSR can generate two kinds of control signals. For example, the same light-emitting control circuit E-VSR can generate the light-emitting control signal, and the light-emitting control signal can be output as the leakage control signal by a connected inverter module, thereby reducing the number of the light-emitting control circuits E-VSR, and realizing the narrow border.

For example, the light-emitting control circuit E-VSR may include a first output terminal, an inverter module, and a second output terminal electrically connected to the inverter module. The first output terminal may be electrically connected to the light-emitting control signal line EM, and the first output terminal is electrically connected to the inverter module. The second output terminal may be electrically connected to the leakage control signal line EMB, and after the inverting action of the inverter module, the signal of the first output terminal can be inverted and output to the second output terminal. The above is merely an example and is not used to limit the present application. In some following examples, the signal on the leakage control signal line EMB may not be correlated with the signal on the light-emitting control signal line EM, for example, the signals may be generated by independent circuits. In this case, the leakage control signal line EMB and the light-emitting control circuit E-VSR may not be connected.

Referring further to FIG. 13, the display panel 1000 may also include a shift register VSR1, and the shift register VSR1 is configured to generate a scanning signal. The shift register VSR1 may include a plurality of cascaded scanning drive circuits S-VSR, and the scanning drive circuits S-VSR may be electrically connected to the pixel circuits 10 by scanning signal lines S(n−1), Sn and S(n+1). The drive chip IC may be bound to the display panel 1000, and the drive chip IC may also be bound to the display module including the display panel. The first power line VDD, the data signal line Vdata, and the reference signal line Vref may be electrically connected to the drive chip IC. In addition, the second power line VSS (not shown in FIG. 13) may be arranged at least partially around the display region of the display panel, and the second power line VSS may also be electrically connected to the drive chip IC.

The drive chip IC provides a first start signal STV1 for the shift register VSR1. Furthermore, as shown in FIG. 13, in the plurality of cascaded scanning drive circuits S-VSR, beside the scanning drive circuits S-VSR of a first stage and a last stage, the other scanning drive circuits S-VSR may provide a scanning signal for two adjacent rows of pixel circuits 10.

The drive chip IC provides a second start signal STV2 for the shift register VSR2.

In addition, a clock signal line (not shown), a high level signal line (VGH) (not shown) and a low level signal line (VGL) (not shown) may be connected between the shift register VSR1 and the drive chip IC as well as between the shift register VSR2 and the drive chip IC, and the drive chip IC can provide a clock signal, a high level signal and a low level signal to the shift register VSR1 and the shift register VSR2.

For example, as shown in FIG. 13, the display panel 1000 may include one shift register VSR1 and one shift register VSR2. The shift register VSR1 and the shift register VSR2 may be arranged on opposite sides of the display panel 1000 in the second direction Y, and the shift register VSR1 and the shift register VSR2 may also be arranged on the same side.

For example, the display panel 1000 may also include two shift registers VSR1 and two shift registers VSR2, two ends of the scanning signal line are electrically connected to one shift register VSR1 respectively, and two ends of the light-emitting control signal line EM as well as two ends of the leakage control signal line EMB are electrically connected to one shift register VSR2 respectively.

The above introduction to the shift register VSR1 and the shift register VSR2 are merely examples and are not used to limit the present application.

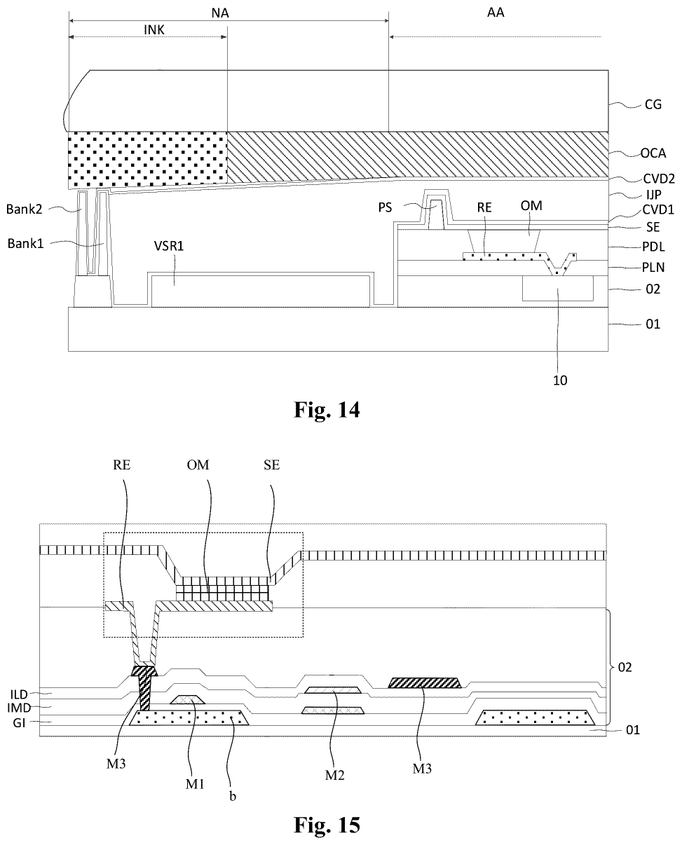

In order to better understand the structure of the display panel provided by the embodiment, please refer to FIGS. 14 to 15. As shown in FIG. 14, the display panel may include a display region AA and a non-display region NA, and the non-display region NA may include an ink region INK. For example, the display panel includes a substrate 01 and a drive circuit layer 02 disposed on a side of the substrate 01. FIG. 14 also illustrates a planarization layer PLN, a pixel definition layer PDL, a light-emitting element (the light-emitting element includes an anode RE, an organic light-emitting layer OM and a cathode SE, wherein a first electrode of the light-emitting element may be the anode RE and a second electrode of the light-emitting element may be the cathode SE), a support column PS, a film packaging layer (including a first inorganic layer CVD1, an organic layer IJP and a second inorganic layer CVD2), an optical glue layer OCA, and a cover plate CG. Further, FIG. 14 also illustrates a shift register VSR1, a first retaining wall Bank1, and a second retaining wall Bank2. The shift register VSR1 may be disposed in the non-display region NA, and the shift register VSR1 may be disposed in the drive circuit layer 02 of the non-display region NA.

The pixel circuit 10 may be disposed in the drive circuit layer 02, and the pixel circuit 10 is connected to the anode RE of the light-emitting element. As shown in FIG. 15, the drive circuit layer 02 of the display panel may include a first metal layer M1, a second metal layer M2 and a third metal layer M3 stacked in a direction away from the substrate 01. A semiconductor layer b is disposed between the first metal layer M1 and the substrate 01. An insulation layer is disposed between any two adjacent metal layers. For example, a gate insulation layer GI is disposed between the first metal layer M1 and the semiconductor layer b, a capacitive insulation layer IMD is disposed between the second metal layer M2 and the first metal layer M1, and an interlayer dielectric layer ILD is disposed between the third metal layer M3 and the second metal layer M2.

The semiconductor layer b may be a semiconductor layer where the active layer of the transistor is located, the first metal layer M1 may be a metal conductive layer where the gate of the transistor is located, the second metal layer M2 may be a metal conductive layer where one of the plates of the capacitor is located, and the third metal layer M3 may be a metal conductive layer where the source and drain of the transistor are located.

For example, the scanning signal lines S(n−1), Sn, S(n+1) and the light-emitting control signal line EM and the leakage control signal line EMB may be disposed in the first metal layer M1. The reference signal line Vref may be disposed in the second metal layer M2, the first power line VDD and the data signal line Vdata may be disposed in the third metal layer M3. Of course, the film layer where each signal line is located may also be arranged in other ways, which is not limited in the present application.

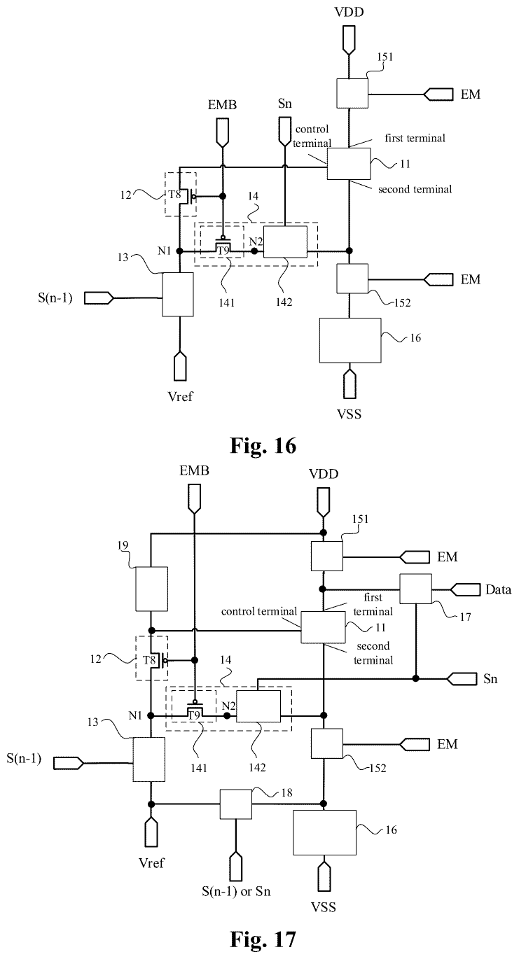

As shown in FIG. 16, the pixel circuit 10 includes a drive module 11, a leakage suppression module 12, a first initialization module 13, and a compensation module 14. The first initialization module 13 and the compensation module 14 are connected to a control terminal of the drive module 11 through the leakage suppression module 12. The compensation module 14 may include a first submodule 141 and a second submodule 142, and the second submodule 142 is connected to the leakage suppression module 12 through the first submodule 141. In FIG. 16, the first initialization module 13 and the compensation module 14 are connected to a first node N1, and one terminal of the leakage suppression module 12 is connected to the control terminal of the drive module 11, the other terminal of the leakage suppression module 12 is connected to the first node N1, and the first submodule 141 and the second submodule 142 are connected to a second node N2.

As an example, as shown in FIG. 16, the pixel circuit may also include a first light-emitting control module 151 and a second light-emitting control module 152. The first light-emitting control module 151 may be connected between a first power line VDD and a second terminal of the drive module 11. The first light-emitting control module 151 may write a signal provided by the first power line VDD to the second terminal of the drive module 11 according to the signal on the light-emitting control signal line EM. The second light-emitting control module 152 may be connected between a first terminal of the drive module 11 and a light-emitting element 16. The second light-emitting control module 152 may transmit the drive current of the drive module 11 to the light-emitting element 16 according to the signal on the light-emitting control signal line EM, so as to drive the light-emitting element 16 to emit light.

The first initialization module 13 may transmit the signal of the reference signal line Vref to the first node N1 according to the signal on the first scanning signal line S(n−1). The second submodule 142 may perform threshold compensation for the drive module 11 according to the signal on the second scanning signal line Sn.

As an example, as shown in FIG. 17, the pixel circuit may also include a data writing module 17, a second initialization module 18, and a storage module 19. The data writing module 17 may be connected between a data signal line Vdata and the second terminal of the drive module 11. The data writing module 17 may be turned on or off according to the signal on the second scanning line Sn. Under a condition that the data writing module 17 is turned on, the data voltage provided by the data signal line Vdata is written to the control terminal of the drive module 11 through the transmission path of the drive module 11, the compensation module 14 and the leakage suppression module 12. The first terminal of the second initialization module 18 is connected to the initialization signal line Vref, the second terminal of the second initialization module 18 is connected to the first terminal of the light-emitting element 16, and the second initialization module 18 may be configured to write the initialization signal provided by the initialization signal line Vref to the first terminal of the light-emitting element 16 according to the signal on the first scanning signal line S(n−1) or the second scanning signal line Sn.

The storage module 19 is connected between the first power line VDD and the control terminal of the drive module 11, and the storage module 19 is configured to store the charge written to the control terminal of the drive module 11.

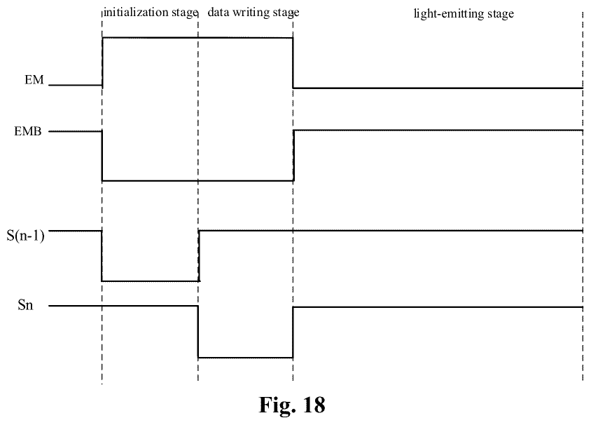

As an example, as shown in FIG. 18, the working process of the pixel circuit may include an initialization stage, a data writing stage, and a light-emitting stage. In the initialization stage, the first initialization module 13 is turned on under the control of the signal on the first scanning line S(n−1), and the signal provided by the initialization signal line Vref is written to the control terminal of the drive module 11 through the first initialization module 13 and the leakage suppression module 12, so that the initialization of the control terminal of the drive module 11 is realized in the initialization stage. In the data writing stage, the first initialization module 13 is turned off under the control of the signal transmitted by the first scanning line S(n−1), the data writing module 17 and the second submodule 142 are turned on under the control of the signal on the second scanning line Sn, and the data voltage provided by the data signal line Vdata is written to the control terminal of the drive module 11 through the data writing module 17, the drive module 11, the second submodule 142, the first submodule 141, the leakage suppression module 14. Since the second submodule 142 may compensate for the threshold value of the drive module 11, the voltage of the control terminal of the drive module 11 includes the voltage associated with the data voltage and the threshold voltage, thereby realizing the data voltage writing and threshold compensation of the drive module 11. Optionally, the second initialization module 18 can be controlled by the signal on the second scanning line Sn. In the data writing stage, the second initialization module 18 is turned on under the control of the signal on the second scanning line Sn, and the signal provided by the initialization signal line Vref is written to the first terminal of the light-emitting element 16 through the second initialization module 18, thereby realizing the initialization of the first terminal of the light-emitting element 16 in the data writing stage, and avoiding the influence of the residual charge of the first terminal of the light-emitting element 16 on the display effect. In the light-emitting stage, the first initialization module 13 is turned off under the control of the signal on the first scanning line S(n−1), the data writing module 17 and the second submodule 142 are turned off under the control of the signal on the second scanning line Sn. The second initialization module 18 is turned off under the control of the signal on the second scanning line Sn, the first light-emitting control module 151 and the second light-emitting control module 152 are turned on under the control of the signal on the light-emitting control signal line EM. Thus, the voltage on the first power line VDD is transmitted to the second terminal of the drive module 11, and the drive module 11 outputs the drive current to drive the light-emitting element 16 to emit light. FIG. 18 gives only one example, and is not used to limit the present application.

As shown in FIG. 16, the leakage suppression module 12 may include an eighth transistor T8, the first submodule 141 may include a ninth transistor T9, and a gate of the eighth transistor T8 and a gate of the ninth transistor T9 are connected to a same signal line. In the present application, the signal line connected to the gate of the eighth transistor T8 and the gate of the ninth transistor T9 is called the leakage control signal line EMB.

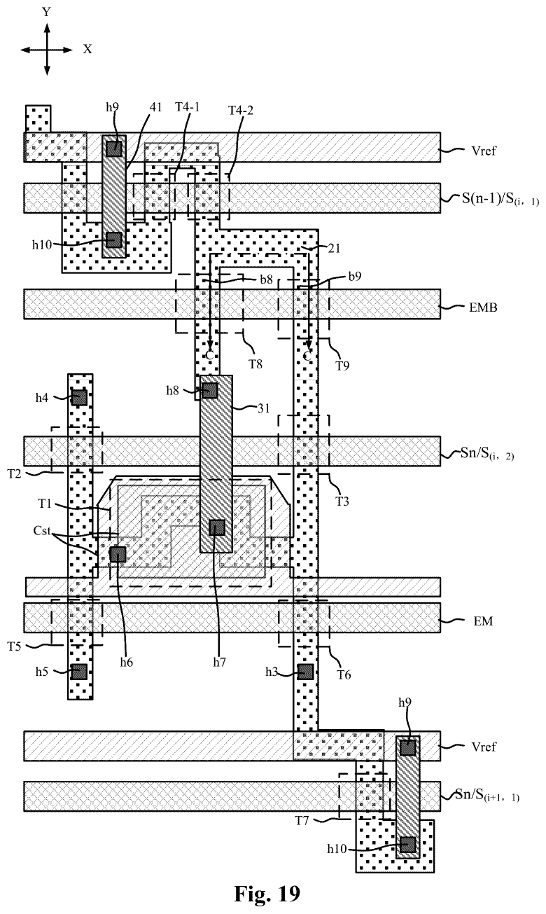

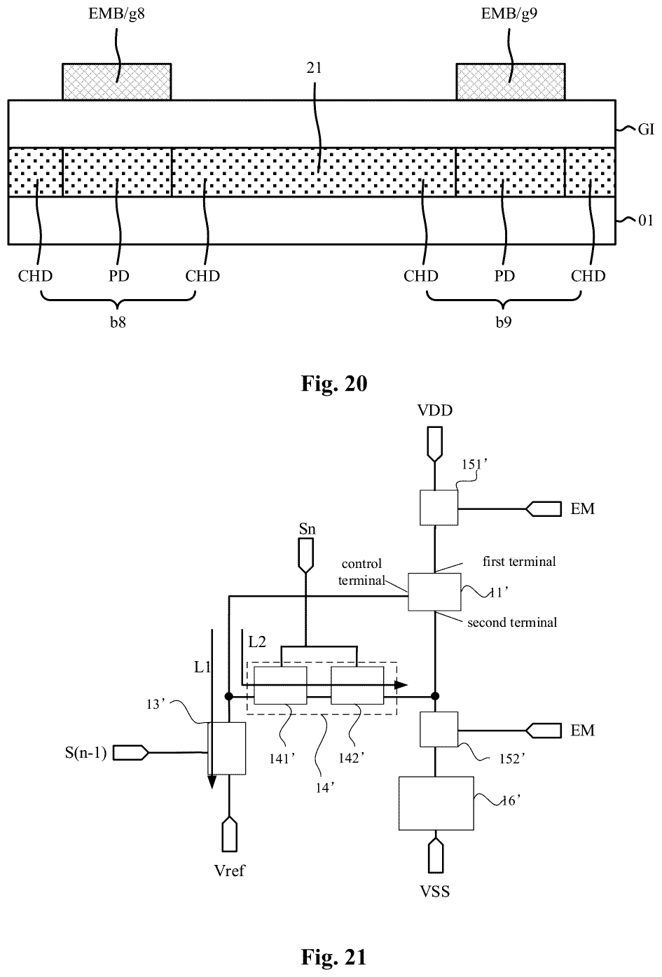

As shown in FIGS. 19 and 20, an active layer b8 of the eighth transistor T8 and an active layer b9 of the ninth transistor T9 are connected through a first connection part 21, and the first connection part 21, the active layer b8 of the eighth transistor T8 and the active layer b9 of the ninth transistor T9 are located in a same membrane layer. For example, the first connection part 21 may be a semiconductor connection part.

As shown in FIG. 20, taking the transistor of the eighth transistor T8 as an example, in a direction perpendicular to the light-emitting surface of the display panel, the portion of the leakage control signal line EMB overlapped with the active layer b8 of the eighth transistor T8 is reused as the gate g8 of the eighth transistor T8. The active layer b8 of the eighth transistor T8 may include a lightly doped region PD and a heavily doped region CHD located on two sides of the lightly doped region PD. In the direction perpendicular to the light-emitting surface of the display panel, the lightly doped region PD is overlapped with the gate g8 of the eighth transistor T8, and the heavily doped region CHD is not overlapped with the gate g8 of the eighth transistor T8. The lightly doped region PD can be understood as the channel region of the active layer b8 of the eighth transistor T8, the heavily doped region CHD can be understood as the source and drain regions of the active layer b8 of the eighth transistor T8, and the source and drain regions of the active layer b8 of the eighth transistor T8 can be the source and drain of the eighth transistor T8. The direction perpendicular to the light-emitting surface of the display panel can be understood as the thickness direction of the display panel.

The first connection part 21, the active layer b8 of the eighth transistor T8 and the active layer b9 of the ninth transistor T9 may be located in the semiconductor layer b shown in FIG. 15, so that the electrical connection of the eighth transistor T8 and the ninth transistor T9 may be realized without setting the hole.

In order to better understand the technical effect of the display panel provided by the embodiment of the present application, please compare and refer to FIG. 21. The pixel circuit shown in FIG. 21 differs from the pixel circuit 10 provided by the embodiment of the present application in that the pixel circuit shown in FIG. 21 is not provided with the leakage suppression module, and the two submodules 141′ and 142′ of the compensation module 14′ shown in FIG. 21 are electrically connected to the second scanning signal line Sn. Further, the drive module 11′, the first initialization module 13′, the light-emitting element control module 151′ and 152′, and light-emitting element 16′ are connected in the same way as the corresponding modules in pixel circuit 10 described in FIG. 16. Since the leakage suppression module is not provided in FIG. 21, the leakage path at the control terminal of the drive module 11′ in FIG. 21 includes two paths, namely, the path L1 that leaks through the first initialization module 13′ and the path L2 that leaks through the compensation module 14′. That is, the control terminal of drive module 11′ will leak through the first initialization module 13′, and the control terminal of drive module 11′ will also leak through the compensation module 14′. Further, if the potential of the control terminal of the drive module 11′ is unstable, it will cause the drive current generated by the drive module 11′ to be unstable, especially in the low-frequency drive mode, which is more likely to lead to the flashing problem of the display panel.

According to the pixel circuit 10 in the display panel provided by the embodiments of the present application, the first initialization module 13 and the compensation module 14 are connected to the control terminal of the drive module 11 through the leakage suppression module 12. Compared with the pixel circuit of FIG. 21, in the present application, the number of the functional modules directly connected to the control terminal of the drive module 11 in the embodiments is reduced from two to one, which is equivalent to reduce the functional modules directly connected to the control terminal of the drive module 11, so that the leakage path of the control terminal of the driver 11 must pass through the leakage suppression module 12. Compared with the case that there are multiple leakage paths of the control terminal of the drive module 11, the potential of the control terminal of the drive module 11 may be more stable, and the flashing problem of the display panel may be improved.

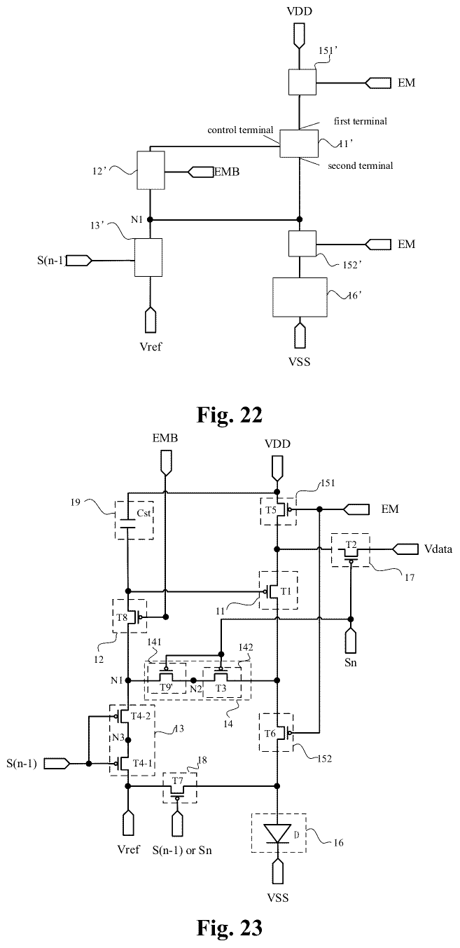

In order to better understand another technical effect of the display panel provided by the embodiment of the present application, please compare and refer to FIG. 22. The similarities between the pixel circuit shown in FIG. 22 and the pixel circuit 10 provided by the embodiment of the present application will not be described in detail, and the differences are that there is no functional module disposed between the leakage suppression module 12′ and the first terminal of the drive module 11′ in the pixel circuit shown in FIG. 22, and the leakage suppression module 12′ and the first terminal of the drive module 11′ are directly connected. For example, the first terminal of the drive module 11′ and the first initialization module 13′ are connected to the first node N1. Due to the direct connection between the first node N1 and the first terminal of the drive module 11′, the potential of the first node N1 is approximately equal to the potential of the first terminal of the drive module 11′. Further, in the light-emitting stage of the working process of the pixel circuit, because that the potential of the first node N1 is approximately equal to the potential of the first terminal of the drive module 11′, and the potential of the control terminal of the drive module 11′ is different from the potential of the first terminal of the drive module 11′, that is, there is a large potential difference between the control terminal and the first terminal of the drive module 11′, so that there is a large potential difference between the control terminal of the drive module 11′ and the first node N1. Under a condition that the equivalent resistance of the leakage suppression module 12′ is unchanged, the greater the potential difference between the two terminals of the leakage suppression module 12′, the greater the leakage current of the control terminal of the drive module 11′ through the leakage suppression module 12′, which is not conducive to the stability of the potential of the control terminal of the drive module 11′.

According to the pixel circuit 10 provided by the embodiments of the present application, the first node N1 and the first terminal of the drive module 11 are not directly connected. The compensation module 14 is disposed between the first node N1 and the first terminal of the drive module 11. Compared with the scheme of direct connection between the first node N1 and the first terminal of the drive module 11, the compensation module 14 has a large resistance, which can divide the voltage in the light-emitting stage, and increase the potential difference between the first node N1 and the first terminal of the drive module 11, thereby reducing the potential difference between the control terminal of the drive module 11 and the first node N1, reducing the leakage current of the control terminal of the drive module 11 through the leakage suppression module 12. Therefore, the stability of the control terminal potential of the drive module 11 is further improved, and the flashing problem of the display panel is mitigated.

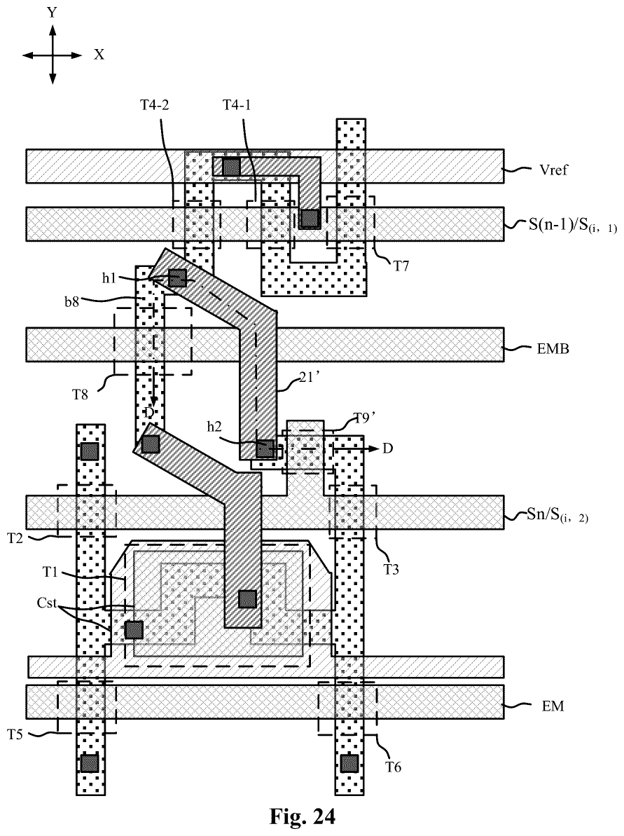

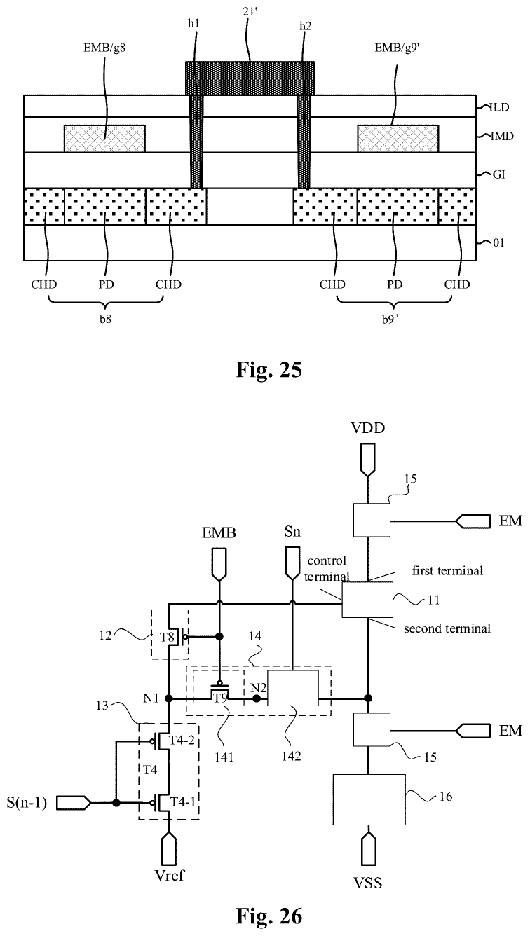

In addition, please refer to FIGS. 23, 24 and 25, the pixel circuits shown in FIGS. 23, 24 and 25 differ from the pixel circuits 10 shown in FIGS. 16 and 19 in that the gate of the transistor T9′ is electrically connected to the second scanning signal line Sn. In order to realize the electrical connection between the eighth transistor T8 and the ninth transistor T9′, the connection part 21′ is located in a different film layer from the active layer b8 of the eighth transistor T8 and the active layer b9′ of the ninth transistor T9′, and is connected to the active layer b8 of the eighth transistor T8 and the active layer b9′ of the ninth transistor T9′ by providing a hole h1 and a hole h2. The hole h1 is connected to the active layer b8 of the eighth transistor T8 and the connection part 21′, and the hole h2 is connected to the active layer b9′ of the ninth transistor T9′ and the connection part 21′.

The display panel provided according to some embodiments of the present application, see FIGS. 19 and 20, may not be additionally provided with the hole h1 and the hole h2, so that the space utilization is higher, and the layout of the high-resolution display panel is more favorable.

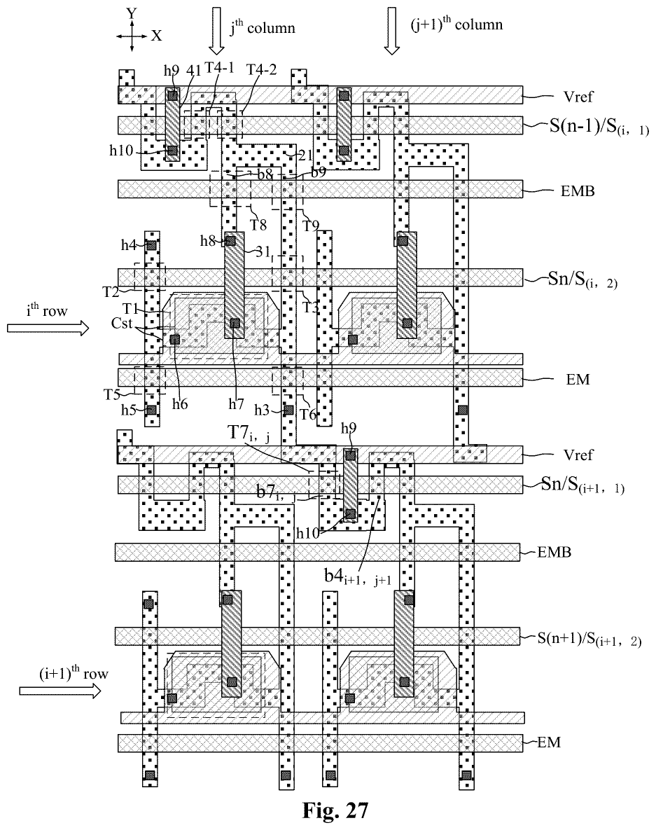

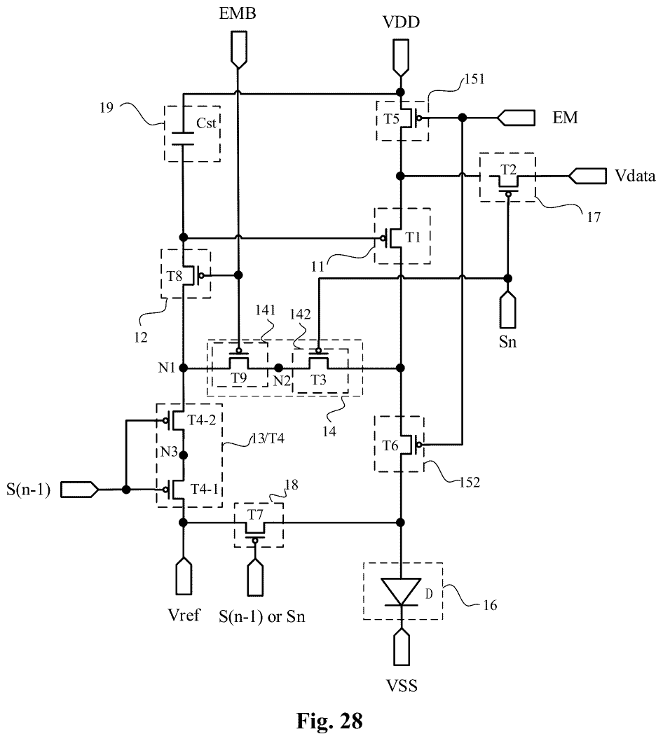

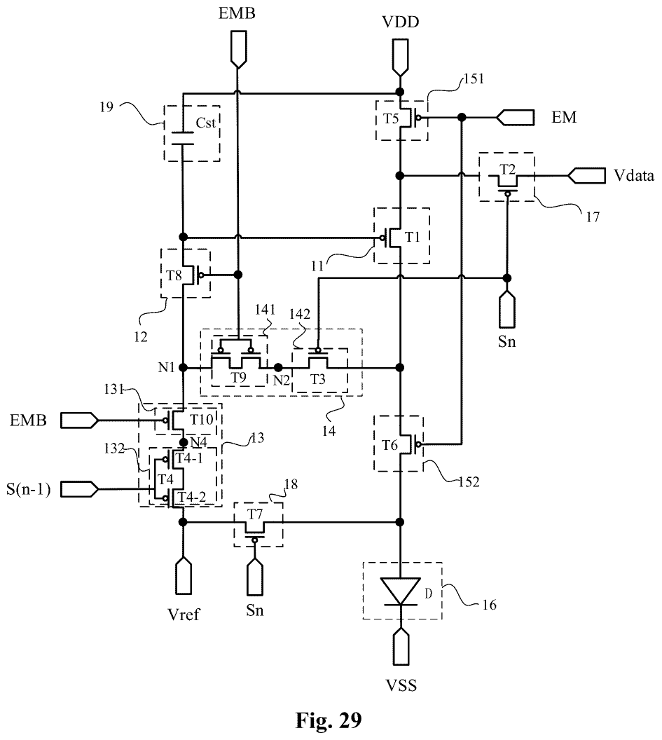

As shown in FIG. 26, the first initialization module 13 of the pixel circuit 10 may include a fourth transistor T4, which may be a dual-gate transistor. For example, the fourth transistor T4 may include a sub-transistor T4-1 and a sub-transistor T4-2. As shown in FIGS. 27 and 28, the pixel circuit 10 further includes a seventh transistor T7 connected between the reference signal line Vref and the first terminal of the light-emitting module 16. Exemplarily, a gate of the seventh transistor T7 may be electrically connected to the second scanning signal line Sn. In FIG. 29, it is illustrated that the gate of the seventh transistor T7 is connected to the second scanning signal line Sn. However, the seventh transistor T7 may also be connected to the first scanning signal line S(n−1), and FIG. 29 is not used to limit the present application.

FIG. 27 illustrates the pixel circuits 10 in an i^{th} row, an (i+1)^{th} row, a j^{th} column, and a (j+1)^{th} column as an example, wherein i and j may be positive integers greater than or equal to 1. The pixel circuits in the i^{th} row are connected to the scanning signal lines S(n−1) and Sn, and the pixel circuits in the (i+1)^{th} row are connected to the scanning signal lines Sn and S(n+1). For the pixel circuits 10 in the i^{th} row, its corresponding first scanning signal line S_{(i, 1)} is the scanning signal line S(n−1), and its corresponding second scanning signal line S_{(i, 2)} is the scanning signal line Sn; for the pixel circuits 10 in the (i+1)^{th} row, its corresponding first scanning signal line S_{(i+1, 1)} is the scanning signal line Sn, and its corresponding second scanning signal line S_{(i+1, 2)} is the scanning signal line S(n+1). It is understood that in two adjacent rows of pixel circuits, the scanning signal line Sn can be used as the second scanning signal line S_{(i, 2)} corresponding to the pixel circuits in the i^{th} row and can be used as the first scanning signal line S_{(i+1, 1)} corresponding to the pixel circuit in the (i+1)^{th} row.

As shown in FIG. 27, the active layer b7_{i, j} of the seventh transistor T7_{i, j} of the pixel circuit 10 in the i^{th} row and the j^{th} column is connected to the active layer b4_{i+1, j+1} of the fourth transistor of the pixel circuit 10 in the (i+1)^{th} row and the (j+1)^{th} column, wherein i and j are positive integers greater than or equal to 1. That is, the active layer of the pixel circuit 10 in the i^{th} row and the j^{th} column is interconnected with the active layer of the pixel circuit 10 in the (i+1)^{th} row and the (j+1)^{th} column. On the one hand, the above arrangement can reasonably lay out the layout design to achieve high resolution. On the other hand, in the process of preparing the active layer, processes such as high temperature processes are required, and the processes such as high temperature processes will generate electrostatic charges, which will have an irreversible effect on the characteristics of the transistor. If the electrostatic charges are unevenly distributed in the active layer of each pixel circuit, it will lead to uneven display. In the embodiment of the present application, because that the active layer of the pixel circuit 10 in the i^{th} row and the j^{th} column is interconnected with the active layer of the pixel circuit 10 in the (i+1)^{th} row and the (j+1)^{th} column, the electrostatic charges can be evenly distributed on the active layer of the pixel circuit 10 in the i^{th} row and the j^{th} column and the active layer of the pixel circuit 10 in the (i+1)^{th} row and the (j+1)^{th} column, so as to improve display uniformity.

In some optional embodiments, as shown in FIG. 16, the control terminal of the first light-emitting control module 151 and the control terminal of the second light-emitting control module 152 are connected to the light-emitting control signal line EM, and the signal line connected to the gate of the eighth transistor T8 and the gate of the ninth transistor T9 is the leakage control signal line EMB. The signal applied on the light-emitting control signal line EM and the signal applied on the leakage control signal line EMB are inverted signals. For example, under a condition that EM is in the high level stage, EMB is at low level, and under a condition that EM is in the low level stage, EMB is at high level. As shown in FIG. 13, the light-emitting control signal line EM and the leakage control signal line EMB connected to the pixel circuits of a same row are connected to the same light-emitting control circuit E-VSR. In this way, a narrow border can be achieved.

As shown in FIG. 28, the drive module 11 may include a first transistor T1. As shown in FIG. 19, the first connection part 21 may be located on the side of the leakage control signal line EMB away from the first transistor T1.

The eighth transistor T8 may be connected to a gate of the first transistor T1 through the second connection part 31, and a connection hole h8 between the eighth transistor T8 and the second connection part 31 may be located on the side of the leakage control signal line EMB near the first transistor T1.

In the present application, the first connection part 21 may be a semiconductor connection part. The second connection part 31 may be a metal connection part.

Exemplarily, as shown in FIG. 28, the drive module 11 may include a first transistor T1, the data writing module 17 includes a second transistor T2, the second submodule 142 includes a third transistor T3, the first initialization module 13 includes a double-gate transistor T4, the double-gate transistor T4 may include a sub-transistor T4-1 and a sub-transistor T4-2, the first light-emitting control module 151 includes a fifth transistor T5, and the second light-emitting control module 152 includes a sixth transistor T6. In FIG. 28, the sub-transistor T4-1 and the sub-transistor T4-2 are connected to a third node N3.

Exemplarily, the gate of the sub-transistor T4-1 and the gate of the sub-transistor T4-2 are connected to the first scanning signal line S(n−1). The gate of the second transistor T2 and the gate of the third transistor T3 are connected to the second scanning signal line Sn. The gate of the fifth transistor T5 can be used as the control terminal of the first light-emitting control module 151, and the gate of the sixth transistor T6 can be used as the control terminal of the second light-emitting control module 152, and the gate of the fifth transistor T5 and the gate of the sixth transistor T6 are connected to the light-emitting control signal line EM. The gates of the eighth transistor T8 and the gate of the ninth transistor T9 are connected to the leakage control signal line EMB.

As an example, please refer to FIGS. 18 and 28, each transistor of the pixel circuit 10 is turned on under a low level and is turned off under a high level, the working process of the pixel circuit 10 may include the following stages.

In the initialization stage, the signal on the light-emitting control signal line EM and the signal on the second scanning signal line Sn are at high level, the signal on the leakage control signal line EMB and the signal on the first scanning signal line S(n−1) are at low level, the eighth transistor T8 and the sub-transistors T4-1 and T4-2 are turned on, and the signal on the reference signal line Vref is transmitted to the gate of the first transistor T1 through the sub-transistors T4-1 and T4-2 and the eighth transistor T8, thereby initializing the gate of the first transistor T1. Since the storage capacitor Cst is electrically connected to the gate of the first transistor T1, the storage capacitor Cst is also initialized in the initialization stage. In addition, in the initialization stage, the ninth transistor T9 is turned on, and the second transistor T2, the third transistor T3, the fifth transistor T5 and the sixth transistor T6 are turned off.

In the data writing stage, the signal on the light-emitting control signal line EM and the signal on the first scanning signal line S(n−1) are at high level, the signal on the leakage control signal line EMB and the signal on the second scanning signal line Sn are at low level, the second transistor T2, the third transistor T3, the ninth transistor T9 and the eighth transistor T8 are turned on, and the data signal of the data signal line Vdata is written to the gate of the first transistor T1. That is, the data signal provided by the data signal line Vdata is written to the gate of the first transistor T1 through the transmission path of the second transistor T2, the first transistor T1, the third transistor T3, the ninth transistor T9 and the eighth transistor T8. Further, the third transistor T3 and the ninth transistor T9 perform threshold compensation for the threshold voltage of the first transistor T1. In addition, in the data writing stage, the fifth transistor T5, the sixth transistor T6, and the sub-transistors T4-1 and T4-2 are turned off.

In the light-emitting stage, the signal on the light-emitting control signal line EM is at low level, the signal on the leakage control signal line EMB, the signal on the first scanning signal line S(n−1) and the signal on the second scanning signal line Sn are at high level, the fifth transistor T5 and the sixth transistor T6 are turned on, the drive current generated by the first transistor T1 is transmitted to the light-emitting diode D, and the light-emitting diode D starts to emit light. In addition, in the light-emitting stage, the second transistor T2, the third transistor T3, the ninth transistor T9, the eighth transistor T8, and the sub-transistors T4-1, T4-2 are turned off.

It is understood that under a condition that the gate of the seventh transistor T7 is electrically connected to the first scanning signal line S(n−1), the seventh transistor T7 is turned on in the initialization stage. Under a condition that the gate of the seventh transistor T7 is electrically connected to the second scanning signal line Sn, the seventh transistor T7 is turned on in the data writing stage. Under a condition that the seventh transistor T7 is turned on, the signal on the reference signal line Vref is transmitted to the first electrode of the light-emitting diode D through the seventh transistor T7, and the first electrode of the light-emitting diode D is initialized.

In some optional embodiments, as shown in FIG. 29, the first initialization module 13 may include a third submodule 131 and a fourth submodule 132, and the fourth submodule 132 is connected to the leakage suppression module 12 through the third submodule 131. For example, the connection node of the fourth submodule 132 and the third submodule 131 is considered to be the fourth node N4. The fourth submodule 132 includes a double-gate transistor T4, for example, the double-gate transistor T4 may include a sub-transistor T4-1 and a sub-transistor T4-2. The third submodule 131 includes a tenth transistor T10, and the ninth transistor T9 may include a double-gate transistor or a multi-gate transistor. That is, the ninth transistor T9 may include at least two sub-transistors connected in series, and the gates of the at least two sub-transistors connected in series are connected to a same signal line.

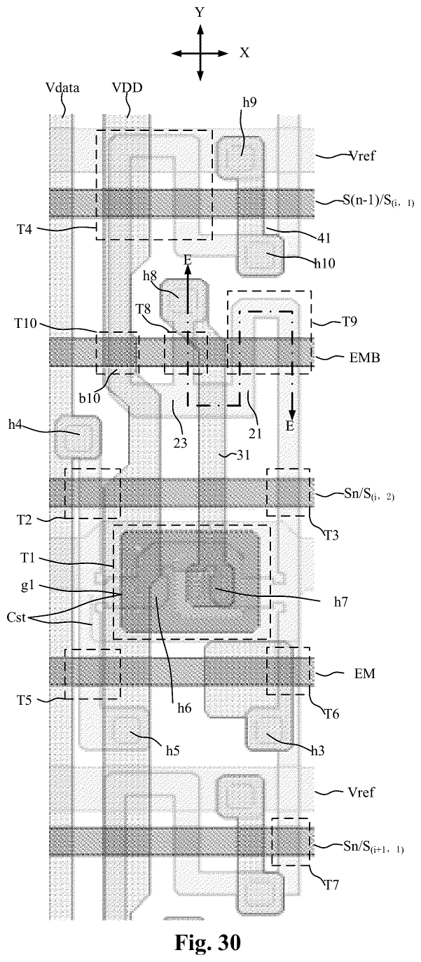

As shown in FIG. 30, the active layer b8 of the eighth transistor T8 is located between the active layer b9 of the ninth transistor T9 and the active layer b10 of the tenth transistor T10. The active layer b8 of the eighth transistor T8 and the active layer b9 of the ninth transistor T9 are connected through a first connection part 21, and the active layer b8 of the eighth transistor T8 and the active layer b10 of the tenth transistor T10 are connected through a third connection part 23. The first connection part 21, the third connection part 23, the active layer b8 of the eighth transistor T8, the active layer b10 of the tenth transistor T10, and the active layer b9 of the ninth transistor T9 are located in the same film layer.

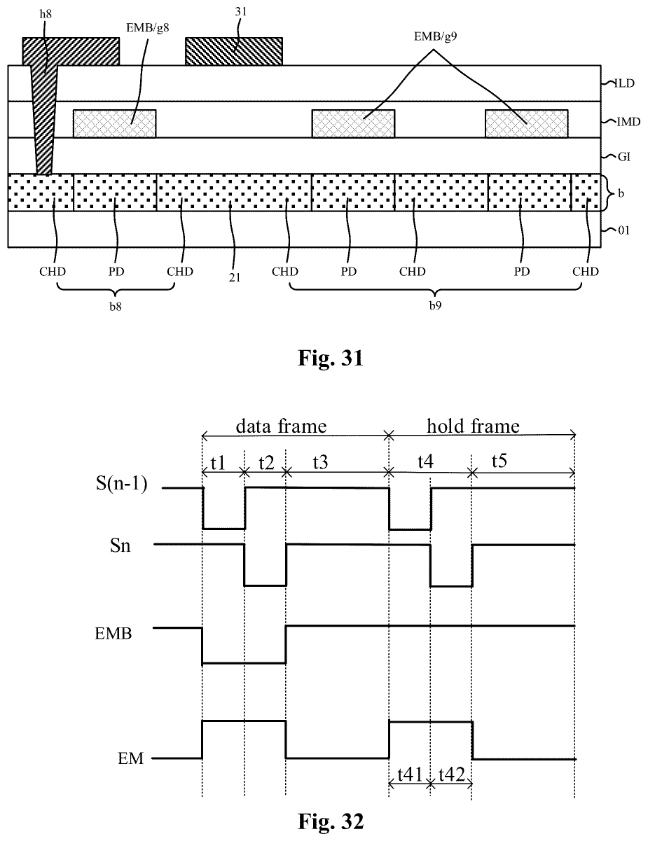

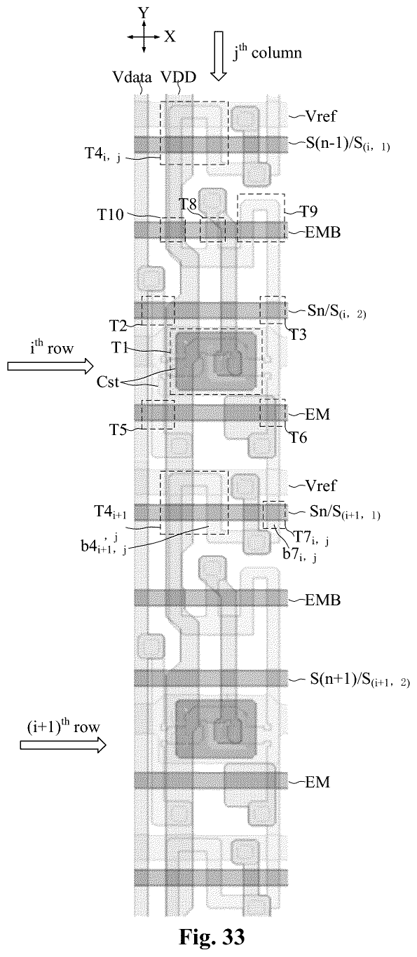

As shown in FIG. 31, the third connection part 23 (not shown in FIG. 31), the active layer b8 of the eighth transistor T8, the active layer b10 of the tenth transistor T10 (not shown in FIG. 31), the active layer b9 of the ninth transistor T9, and the first connection part 21 can be located in the semiconductor layer b shown in FIG. 15, so that the electrical connection between the eighth transistor T8 and the ninth transistor T9 as well as the electrical connection between the eighth transistor T8 and the tenth transistor T10 may be realized without setting the hole.

In the present application, the third connection part 23 may be a semiconductor connection part.

The display panel may support a low-frequency mode. In order to reduce power consumption, exemplarily, as shown in FIG. 32, in the low-frequency mode, the working process of the pixel circuit in the display panel may include a data frame and a hold frame. Exemplarily, one data frame may be followed by one or more hold frames. In a high-frequency mode, the working process of the pixel circuit in the display panel may include only the data frame.

Exemplarily, in the high-frequency mode and the low-frequency mode, the frequencies of the scanning signal may be the same. Thus, even if the display panel is displayed in the low-frequency mode, it can also give the user the visual effect of the high-frequency mode. In the low-frequency mode, as shown in FIG. 32, the signal applied on the first scanning line S(n−1) may be the same in the data frame and the hold frame, and the signal applied on the second scanning line Sn may be the same in the data frame and the hold frame.

In some optional embodiments, as shown in FIGS. 29 and 32, the data frame may include an initialization stage t1. In the initialization stage t1, the fourth transistor T4 (including the sub-transistor T4-1 and the sub-transistor T4-2) and the tenth transistor T10 are turned on. In the hold frame, the tenth transistor T10 is turned off. The gate of the fourth transistor T4 may be connected to the first scanning signal line S(n−1), and the gate of the tenth transistor T10 is connected to the leakage control signal line EMB.

Exemplarily, in the data frame, the data signal may be transmitted to the control terminal of the drive module, and in the hold frame, the data signal may not be transmitted to the control terminal of the drive module. The light-emitting element 16 may be initialized in the hold frame, thereby reducing the flashing.

For example, as shown in FIG. 29, the pixel circuit 10 may also include a second initialization module 18, and the second initialization module 18 is configured to transmit the signal of the reference signal line Vref to the first electrode of the light-emitting element 16 under the control of the scanning signal Sn. For example, in the hold frame, the second initialization module 18 may be turned on for a period of time to transmit the signal of the reference signal line Vref to the first electrode of the light-emitting element 16, thereby initializing the first electrode of the light-emitting element 16.

The inventor found that, as shown in FIGS. 29 and 32, the fourth transistor T4 and the second initialization module 18 can be turned on or off under the control of the scanning signal. For example, the fourth submodule 132 and the second initialization module 18 can be turned on or off under the control of the scanning signals S(n−1) and Sn generated by the gate drive circuit of the display panel. The second initialization module 18 may be turned on for a period of time in the hold frame, and the fourth submodule 132 may also be turned on for a period of time in the hold frame, and the signal of the reference signal line Vref may be transmitted to the fourth node N4 in the hold frame. If the tenth transistor T10 is not disposed, the signal of the reference signal line Vref may be transmitted directly to the first node N1 in the hold frame. Exemplarily, the signal of the reference signal line Vref is a constant negative voltage, and the potential of the control terminal of the drive module 11 in the hold frame is a positive potential. Thus, the difference between the potential of the control terminal of the drive module 11 and the potential of the first node N1 in the hold frame is large, thereby causing the increasing of the leakage current through the leakage suppression module 12, causing the instability of the potential of the control terminal of the drive module 11 in the hold frame, and causing the flashing problem. In the embodiment of the present application, by setting the tenth transistor T10 and turning off the tenth transistor T10 in the hold frame, the signal of the reference signal line Vref can be avoided from being directly transmitted to the first node N1 in the hold frame, so that the potential difference between the control terminal of the drive module 11 and the first node N1 is small in the hold frame. That is, the potential difference between the two terminals of the leakage suppression module 12 is small, thereby reducing the leakage current through the leakage suppression module 12, stabilizing the potential of the control terminal of the drive module 11, and avoiding the flashing problem.

As shown in FIGS. 29 and 32, the data frame may also include a data writing stage t2. In the data writing stage t12, the first submodule 141 may be turned on under the control of the low level of the leakage control signal line EMB, and the second submodule 142 may be turned on under the control of the low level of the second scanning signal line Sn. In the hold frame, the leakage control signal line EMB may always be at high level, so that the first submodule 141 may always be turned off under the control of the high level of the leakage control signal line EMB.

The inventor also found that, as shown in FIG. 29, the second submodule 142 can be turned on or off under the control of the scanning signal, for example, the second submodule 142 can be turned on or off under the control of the scanning signal generated by the gate drive circuit of the display panel. The second initialization module 18 may be turned on for a period of time in the hold frame, and the second submodule 142 may also be turned on for a period of time in the hold frame. Since the second submodule 142 may also turned be on for a period of time in the hold frame, the pixel circuits of a same column may be connected to a same data signal line, and the data signals required by other pixel circuits in the same column of pixel circuits 10 may be transmitted to the second nodes N2 of the pixel circuits 10 in the hold frame. As shown in FIG. 29, the data signal is transmitted to the second node N2 of the pixel circuit 10 through the data writing module 17, the drive module 11, and the second submodule 142 in the hold frame. Under a condition that the first submodule 141 is not provided, the data signals required by other pixel circuits in the same column of pixel circuits may be transmitted to the first node N1 directly through the data writing module 17, the drive module 11, and the second submodule 142 in the hold frame. The data signals required by the pixel circuits of the same column in the same frame are quite different, such that the difference between the potential of the control terminal of the drive module 11 and the potential of the first node N1 is large in the hold frame, thereby causing the increasing of the leakage current of the leakage suppression module 12, causing the instability of the potential of the control terminal of the drive module 11 in the hold frame, and causing the flashing problem. In the embodiment of the present application, by setting the first submodule 141 and turning off the first submodule 141 in the hold frame, the data signals required by other pixel circuits can be avoided from being transmitted to the first node N1 in the hold frame, so that the difference between the potential of the control terminal of the drive module 11 and the potential of the first node N1 is small in the hold frame, thereby further stabilizing the potential of the control terminal of the drive module 11, and avoiding the flashing problem.

In some optional embodiments, as shown in FIG. 29, for example, the second initialization module 18 includes a seventh transistor T7. Please refer to FIG. 21, the active layer b7_{i, j} of the seventh transistor T7_{i, j} of the pixel circuit 10 in the i^{th} row and the j^{th} column is connected to the active layer b4^{i+1, j} of the double-gate transistor T_{4i+1, j} of the pixel circuit 10 in the (i+1)^{th} row and the j^{th} column, wherein i and j are positive integers greater than or equal to 1. Such interconnection of the active layers of the pixel circuits in the same column may simplify the layout design, and is more conducive to achieving high resolution.

Exemplarily, the gate of the seventh transistor T7_{i, j} of the pixel circuit 10 in the i^{th} row and the j^{th} column and the gate of the double-gate transistor T4_{i+1, j} of the pixel circuit 10 in the (i+1)^{th} row and the j^{th} column are connected to the same scanning line Sn. By sharing the scanning line, the number of the scanning lines required can be reduced, which is more conducive to achieving high resolution.

As shown in FIG. 30, the leakage control signal line EMB may extend in the first direction X, and the gate of the eighth transistor T8, the gate of the tenth transistor T10, and the gate of the ninth transistor T9 are connected to the same leakage control signal line EMB. This can reduce the number of the leakage control signal lines EMB, and is more conducive to achieving high resolution.

Referring to FIG. 30, the drive module 11 may include a first transistor T1, the gate g1 of the first transistor T1 is connected to the second connection part 31, and the gate g1 of the first transistor T1 is used as the control terminal of the drive module. The eighth transistor T8 is connected to the second connection part 31 through the eighth hole h8, and the eighth hole h8 may be located on the side of the leakage control signal line EMB away from the first transistor T1. For example, the lower plate of the storage capacitor Cst can be reused as the gate g1 of the first transistor T1. In order to improve the stability of the potential of the gate g1 of the first transistor T1, the area of the gate g1 may be configured sufficiently large. By setting the eighth hole h8 on the side of the leakage control signal line EMB away from the first transistor T1, sufficient space for the gate g1 having a large area can be set without reducing the pixel density.

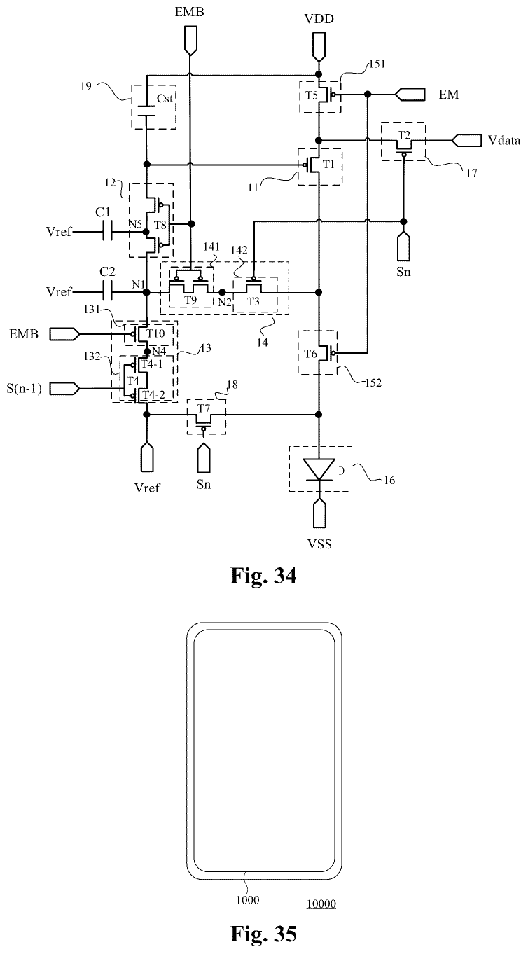

As shown in FIG. 34, the first electrode of the eighth transistor T8 is connected to the gate of the first transistor T1, the eighth transistor T8 may include a double-gate transistor, and the pixel circuit 10 further includes a first capacitor C1 and/or a second capacitor C2. The first terminal of the first capacitor C1 is connected to a connection node N5 between the two sub-transistors of the eighth transistor T8, which is also called as the double-gate node N5, the second terminal of the first capacitor C1 is connected to a constant voltage signal line, and the constant voltage signal line includes the first power line VDD or the reference signal line Vref. The first terminal of the second capacitor C2 is connected to the second electrode of the eighth transistor T8, the second terminal of the second capacitor C2 is connected to a constant voltage signal line, and the constant voltage signal line includes the first power line VDD or the reference signal line Vref. The capacitance value of the first capacitor C1 is 10 fF to 60 fF. The capacitance value of the second capacitor C2 is 10 fF to 60 fF. Since the signal on the first power line VDD or the reference signal line Vref is a constant voltage signal, the first capacitor C1 and the second capacitor C2 may stabilize the voltage. Further, the greater the capacitance values of the first capacitor C1 and the second capacitor C2, the stronger the voltage stabilizing capacity. Since the capacitance values of the first capacitor and the second capacitor are relatively large, the potential of the double-gate node N5 of the eighth transistor T8 and the potential of the second electrode of the eighth transistor T8 may be better stabilized.

For example, one of the first electrode and the second electrode of the eighth transistor T8 may be a source, and the other may be a drain.

As another example, with reference to FIGS. 34 and 32, for example, the transistors of the pixel circuit 10 are turned on under the low level and are turned off under the high level. The data frame may include an initialization stage t1, a data writing stage t2 and a first light-emitting stage t3, and the hold frame may include a non-light-emitting stage t4 and a second light-emitting stage t5. The non-light-emitting stage t4 may include a first stage t41 and a second stage t42.

In the initialization stage t1, the signal on the light-emitting control signal line EM and the signal on the second scanning signal line Sn are at high level, the signal on the leakage control signal line EMB and the signal on the first scanning signal line S(n−1) are at low level, the eighth transistor T8, the fourth transistor T4 and the tenth transistor T10 are turned on, and the signal on the reference signal line Vref is transmitted to the gate of the first transistor T1, so as to initialize the gate of the first transistor T1. Since the storage capacitor Cst is electrically connected to the gate of the first transistor T1, the storage capacitor Cst is also initialized in the initialization stage. Further, in the initialization stage t1, the ninth transistor T9 is turned on, the second transistor T2, the third transistor T3, the fifth transistor T5 and the sixth transistor T6 are turned off.

In the data writing stage t2, the signal on the light-emitting control signal line EM and the signal on the first scanning signal line S(n−1) are at high level, the signal on the leakage control signal line EMB and the signal on the second scanning signal line Sn are at low level, the second transistor T2, the third transistor T3, the ninth transistor T9, and the eighth transistor T8 are turned on, and the data signal of the data signal line Vdata is written to the gate of the first transistor T1 through the second transistor T2, the first transistor T1, the third transistor T3, the ninth transistor T9 and the eighth transistor T8. Further, the third transistor T3 and the ninth transistor T9 perform threshold compensation for the threshold voltage of the first transistor T1. Further, in the data writing stage t2, the seventh transistor T7 is turned on, and the signal on the reference signal line Vref is transmitted to the first electrode of the light-emitting element D to initialize the light-emitting element D. Also, in the data writing stage T2, the fifth transistor T5, the sixth transistor T6 and the double gate transistor T4 are turned off.

In the first light-emitting stage t3 of the data frame and the second light-emitting stage t5 of the hold frame, the signal on the light-emitting control signal line EM is at low level, the signal on the leakage control signal line EMB, the signal on the first scanning signal line S(n−1) and the signal on the second scanning signal line Sn are at high level, the fifth transistor T5 and the sixth transistor T6 are turned on, and the driving current generated by the first transistor T1 is transmitted to the light-emitting diode D, and the light-emitting diode D starts to emit light. Further, in the light-emitting stages t3 and t5, the second transistor T2, the third transistor T3, the ninth transistor T9, the eighth transistor T8, and the fourth transistor T4 and the tenth transistor T10 are turned off.

In the first stage t41, the signal on the light-emitting control signal line EM, the signal on the leakage control signal line EMB and the signal on the second scanning signal line Sn are at high level, and the signal on the first scanning signal line S(n−1) is at low level. The fourth transistor T4 is turned on, the signal on the reference signal line Vref is transmitted to the fourth node N4. Further, the tenth transistor T10 is turned off, the signal on the reference signal line Vref is not transmitted to the first node N1. In addition, the second transistor T2, the third transistor T3, the ninth transistor T9, the eighth transistor T8, the fifth transistor T5, the sixth transistor T6, and the seventh transistor T7 are turned off.

In the second stage t42, the signal on the light-emitting control signal line EM, the signal on the leakage control signal line EMB and the signal on the first scanning signal line S(n−1) are at high level, and the signal on the second scanning signal line Sn is at low level. The seventh transistor T7 is turned on, the signal on the reference signal line Vref is transmitted to the first electrode of the light-emitting element D, and the first electrode of the light-emitting element D is initialized. The second transistor T2 and the third transistor T3 are turned on, and the signal of the data signal line Vdata is transmitted to the second node N2. Since the ninth transistor T9 is turned off, the signal of the data signal line Vdata is not transmitted to the first node N1. In addition, the eighth transistor T8, the fifth transistor T5, the sixth transistor T6, the tenth transistor T10, and the fourth transistor T4 are turned off.

In the present application, as an example, the first power line VDD can be configured to transmit a positive voltage, for example, the voltage transmitted on the first power line VDD can be +4.6V. The second power line VSS can be configured to transmit a negative voltage, for example, the voltage transmitted on the second power line VSS can be −2.5V. The first scanning signal line S(n−1) and the second scanning signal line Sn are configured to transmit the scanning signals, and the light-emitting control signal line EM and the leakage control signal line EMB are configured to transmit the light-emitting control signal and the leakage control signal. The scanning signals, the light-emitting control signal and the leakage control signal may be pulse signals, the high level of the scanning signals, the light-emitting control signal and the leakage control signal may be +7V, and the low level may be −7V. The reference signal line Vref is configured to transmit a negative voltage. For example, the voltage on the reference signal line Vref can be −3.5V. The above values are only some examples, and are not used to limit the present application.

Further, in the local structure diagram of the display panel provided by the present application, the hole h3 can be understood as a connection hole between the pixel circuit 10 and the first electrode of the light-emitting diode D. The hole h4 can be understood as a connection hole between the second transistor T2 and the data signal line Vdata. The hole h5 can be understood as a connection hole between the fifth transistor T5 and the first power line VDD. The hole h6 can be understood as a connection hole between the upper plate of the storage capacitor Cst and the first power line VDD. The lower plate of the storage capacitor Cst can be reused as the gate of the first transistor T1, and the gate of the first transistor T1 are connected to the eighth transistor T8 through the second connection part 31. The hole h7 can be understood as a connection hole between the second connection part 31 and the gate of the first transistor T1, and the hole h8 can be understood as a connection hole between the second connection part 31 and the eighth transistor T8. The reference signal line Vref is connected to the seventh transistor T7 and the sub-transistors T4-1 and T4-2 through the connection part 41. The hole h9 can be understood as a connection hole between the connection part 41 and the reference signal line Vref, and the hole h10 can be understood as a connection hole between the connection part 41 and the seventh transistor T7 as well as the sub-transistors T4-1 and T4-2.

The present application further provides a display device including the display panel provided by the present application. Referring to FIG. 35, FIG. 35 is a schematic structure diagram of a display device provided by an embodiment of the present application. The display device 10000 provided in FIG. 35 includes the display panel 1000 provided in any above embodiment of the present application. The embodiment of FIG. 35 illustrates the display device 10000 as a cellphone. It is understood that the display device provided by the embodiment of the present application may be other display devices with display functions such as a wearable product, a computer, a TV, an in-vehicle display device, which is not limited in the present application. The display device provided by the embodiment of the present application has the beneficial effect of the display panel provided by the embodiments of the present application, and the beneficial effect may be specifically referred to the description of the display panel in the above embodiments, which will not be repeated in this embodiment.

According to the embodiments of the present application as described above, these embodiments do not describe all the details and do not limit the present application to the specific embodiments as described. Obviously, there are many modifications and changes that can be made based on the above description. This specification selects and describes these embodiments in order to better explain the principle and practical application of the present application, so that those skilled in the art can make good use of the present application and the modification of the present application. The present application is limited only by the claim and its full scope and equivalents.

What is claimed is:

1. A pixel circuit comprising a drive module, a storage module, a compensation module, a first initialization module, a light-emitting module, a light-emitting control module and a leakage suppression module;
wherein the storage module is connected to a control terminal of the drive module, and is configured to store a voltage of the control terminal of the drive module;
the light-emitting control module, the drive module and the light-emitting module are connected between a first power line and a second power line, and the light-emitting control module is configured to control, based on a signal on a light-emitting control signal line, the light-emitting module to emit light according to a drive current output by the drive module;
a first terminal of the first initialization module is connected to an initialization signal line, a second terminal of the first initialization module is connected to the control terminal of the drive module through the leakage suppression module, and the first initialization module is configured to write an initialization voltage provided by the initialization signal line to the control terminal of the drive module according to a signal on a first scanning line;
a first terminal of the compensation module is connected to a first terminal of the drive module, a second terminal of the compensation module is connected to the control terminal of the drive module through the leakage suppression module, and the compensation module is configured to perform threshold compensation for the drive module according to a signal on a second scanning line.

2. The pixel circuit according to claim 1, wherein at least one node of a node of an internal device of the first initialization module, a node of an internal device of the leakage suppression module, a node connected to the leakage suppression module and the first initialization module, a node connected to the leakage suppression module and the control terminal of the drive module, and a node connected to the leakage suppression module and the compensation module is connected with a voltage stabilization capacitor,
wherein a first electrode of the voltage stabilization capacitor is connected to one node of the node of the internal device of the first initialization module, the node of the internal device of the leakage suppression module, the node connected to the leakage suppression module and the first initialization module, the node connected to the leakage suppression module and the control terminal of the drive module, and the node connected to the leakage suppression module and the compensation module, and a second electrode of the voltage stabilization capacitor is connected to a signal line,
wherein a control terminal of the leakage suppression module is connected to a leakage control signal line, the signal line comprises a constant voltage signal line or a pulse signal line, the constant voltage signal line comprises the initialization signal line or the first power line, and the pulse signal line comprises the leakage control signal line,
wherein the storage module comprises a storage capacitor, and a capacitance value of the voltage stabilization capacitor is less than a capacitance value of the storage capacitor.

3. The pixel circuit according to claim 2, wherein the voltage stabilization capacitor comprises a first voltage stabilization capacitor and a second voltage stabilization capacitor;
a first electrode of the first voltage stabilization capacitor is connected to the control terminal of the drive module, and a second electrode of the first voltage stabilization capacitor is connected to the leakage control signal line;
a first electrode of the second voltage stabilization capacitor is connected to the node of the internal device of the leakage suppression module, and a second electrode of the second voltage stabilization capacitor is connected to the initialization signal line.

4. The pixel circuit according to claim 1, wherein the leakage suppression module comprises a first transistor and a second transistor;
a first electrode of the first transistor is connected to the control terminal of the drive module, and a second electrode of the first transistor is connected to the second terminal of the first initialization module;
a first electrode of the second transistor is connected to the second electrode of the first transistor, and a second electrode of the second transistor is connected to the second terminal of the compensation module;
a gate of the first transistor and a gate of the second transistor are connected to a leakage control signal line.

5. The pixel circuit according to claim 4, wherein the first initialization module comprises a first submodule and a second submodule, the first submodule is connected between the second submodule and the second electrode of the first transistor, and the second submodule is connected between the first submodule and the initialization signal line;
a working process of the pixel circuit comprises a data frame and a hold frame, and the data frame comprises an initialization stage;
in the initialization stage, the first submodule and the second submodule are turned on;
in the hold frame, at least one of the first submodule and the second transistor is turned off.

6. The pixel circuit according to claim 4, wherein the light-emitting control module comprises a first light-emitting control module and a second light-emitting control module;
the first light-emitting control module is connected between the first power line and a second terminal of the drive module, the second light-emitting control module is connected between the first terminal of the drive module and a first terminal of the light-emitting module, a second terminal of the light-emitting module is connected to the second power line, and a control terminal of the first light-emitting control module and a control terminal of the second light-emitting control module are connected to the light-emitting control signal line.

7. The pixel circuit according to claim 6, wherein within a frame, a low level interval of a signal on the leakage control signal line is within a high level interval of a signal on the light-emitting control signal line,
wherein the signal on the leakage control signal line and the signal on the light-emitting control signal line are inverted to each other.

8. The pixel circuit according to claim 5, wherein the second submodule comprises a sixth transistor, and the first submodule comprises a tenth transistor;
a first electrode of the sixth transistor is used as the first terminal of the first initialization module, a second electrode of the sixth transistor is connected to a first electrode of the tenth transistor, a second electrode of the tenth transistor is connected to the leakage suppression module, a gate of the sixth transistor is connected to the first scanning line, and a gate of the tenth transistor is connected to the leakage control signal line;
the second transistor comprises a double-gate transistor.

9. The pixel circuit according to claim 6, wherein the pixel circuit further comprises a data writing module and a second initialization module; the data writing module comprises a third transistor, the drive module comprises a fourth transistor; the compensation module comprises a fifth transistor, the first initialization module comprises a sixth transistor; the second initialization module comprises a seventh transistor; the first light-emitting control module comprises an eighth transistor, and the second light-emitting control module comprises a ninth transistor;
a first electrode of the third transistor is connected to a data signal line, a second electrode of the third transistor is connected to the second terminal of the drive module, and a gate of the third transistor is connected to the second scanning line;
a first electrode of the fourth transistor is used as the second terminal of the drive module, a second electrode of the fourth transistor is used as the first terminal of the drive module, and a gate of the fourth transistor is used as the control terminal of the drive module;
a first electrode of the fifth transistor is used as the first terminal of the compensation module, a second electrode of the fifth transistor is used as the second terminal of the compensation module, and a gate of the fifth transistor is connected to the second scanning line;
a first electrode of the sixth transistor is used as the first terminal of the first initialization module, a second electrode of the sixth transistor is used as the second terminal of the first initialization module, and a gate of the sixth transistor is connected to the first scanning line;
a first electrode of the seventh transistor is connected to the initialization signal line, a second electrode of the seventh transistor is connected to the first terminal of the light-emitting module, and a gate of the seventh transistor is connected to a third scanning line;
a first electrode of the eighth transistor is connected to the first power line, a second electrode of the eighth transistor is connected to the first electrode of the fourth transistor, and a gate of the eighth transistor is connected to the light-emitting control signal line;
a first electrode of the ninth transistor is connected to the second electrode of the fourth transistor, a second electrode of the ninth transistor is connected to the first terminal of the light-emitting module, and a gate of the ninth transistor is connected to the light-emitting control signal line;
at least one of the first transistor and the sixth transistor comprises a double-gate transistor.

10. The pixel circuit according to claim 9, wherein the pixel circuit further comprises a first capacitor, a second capacitor, a third capacitor, a fourth capacitor and a fifth capacitor;
the first transistor and the sixth transistor comprise a double-gate transistor;
a first electrode of the first capacitor is connected to the gate of the fourth transistor, a second electrode of the first capacitor is connected to the leakage control signal line, a first electrode of the second capacitor is connected to the second electrode of the sixth transistor, a second electrode of the second capacitor is connected to the initialization signal line, a first electrode of the third capacitor is connected to the second electrode of the second transistor, a second electrode of the third capacitor is connected to the initialization signal line, a first electrode of the fourth capacitor is connected to a double-gate node of the sixth transistor, a second electrode of the fourth capacitor is connected to the initialization signal line, a first electrode of the fifth capacitor is connected to the initialization signal line, and a second electrode of the fifth capacitor is connected to a double-gate node of the first transistor.

11. A pixel circuit comprising a drive module, a storage module, a compensation module, a first initialization module, a light-emitting module, a light-emitting control module and a leakage suppression module;
wherein the storage module is connected to a control terminal of the drive module, and is configured to store a voltage of the control terminal of the drive module;
the light-emitting control module, the drive module and the light-emitting module are connected between a first power line and a second power line, and the light-emitting control module is configured to control, based on a signal on a light-emitting control signal line, the light-emitting module to emit light according to a drive current output by the drive module;
a first terminal of the first initialization module is connected to an initialization signal line, a second terminal of the first initialization module is connected to a first terminal of the leakage suppression module, and the first initialization module is configured to write an initialization voltage provided by the initialization signal line to the control terminal of the drive module according to a signal on a first scanning line;
a first terminal of the compensation module is connected to a first terminal of the drive module, a second terminal of the compensation module is connected to a second terminal of the leakage suppression module, and the compensation module is configured to perform threshold compensation for the drive module according to a signal on a second scanning line;
a third terminal of the leakage suppression module is connected to the control terminal of the drive module, and at least one of the first terminal and the second terminal of the leakage suppression module is connected with a capacitor.

12. The pixel circuit according to claim 11, wherein a first electrode of the capacitor is connected to the first terminal or the second terminal of the leakage suppression module, and a second electrode of the capacitor is connected to a signal line,
wherein a control terminal of the leakage suppression module is connected to a leakage control signal line, the signal line comprises a constant voltage signal line or a pulse signal line, the constant voltage signal line comprises the initialization signal line or the first power line, and the pulse signal line comprises the leakage control signal line.

13. The pixel circuit according to claim 11, wherein the leakage suppression module comprises a first transistor and a second transistor;
a first electrode of the first transistor is used as the third terminal of the leakage suppression module and is connected to the control terminal of the drive module;
a second electrode of the first transistor is used as the first terminal of the leakage suppression module and is connected to the second terminal of the first initialization module;
a second electrode of the second transistor is used as the second terminal of the leakage suppression module and is connected to the second terminal of the compensation module,
wherein the second electrode of the first transistor is connected to a first electrode of the second transistor, and a gate of the first transistor and a gate of the second transistor are connected to a leakage control signal line.

14. A display panel comprising one or more pixel circuits, wherein the pixel circuit comprises a drive module, a leakage suppression module, a first initialization module and a compensation module;
the first initialization module and the compensation module are connected to a control terminal of the drive module through the leakage suppression module, the compensation module comprises a first submodule and a second submodule, and the second submodule is connected to the leakage suppression module through the first submodule;
the leakage suppression module comprises an eighth transistor, the first submodule comprises a ninth transistor, a gate of the eighth transistor and a gate of the ninth transistor are connected to a same signal line, an active layer of the eighth transistor and an active layer of the ninth transistor are connected by a first connection part, and the first connection part, the active layer of the eighth transistor and the active layer of the ninth transistor are located in a same film layer, wherein the first connection part is a semiconductor connection part.

15. The display panel according to claim 14, wherein the pixel circuit further comprises a seventh transistor connected to a first electrode of a light-emitting element of the display panel;
an active layer of the seventh transistor of the pixel circuit in an i^{th} row and a j^{th} column is connected to an active layer of the fourth transistor of the pixel circuit in an (i+1)^{th} row and a (j+1)^{th} column, wherein i and j are positive integers greater than or equal to 1.

16. The display panel according to claim 14, wherein the display panel further comprises a shift register, and the shift register comprises light-emitting control circuits that are multistage cascaded;
the pixel circuit further comprises a first light-emitting control module and a second light-emitting control module, the first light-emitting control module is connected between a first power line and a second terminal of the drive module, and the second light-emitting control module is connected between a first terminal of the drive module and a first electrode of a light-emitting element of the display panel;
a control terminal of the first light-emitting control module and a control terminal of the second light-emitting control module are connected to a light-emitting control signal line, and the signal line connected to the gate of the eighth transistor and the gate of the ninth transistor is a leakage control signal line;
the drive module comprises a first transistor, and the first connection part is located on a side of the leakage control signal line away from the first transistor;
the eighth transistor is connected to a gate of the first transistor through a second connection part, and a connection hole between the eighth transistor and the second connection part is located on a side of the leakage control signal line near the first transistor,
wherein a signal on the light-emitting control signal line and a signal on the leakage control signal line are inverted signals, and the light-emitting control signal line and the leakage control signal line connected to a same row of the pixel circuits are connected to a same light-emitting control circuit.

17. The display panel according to claim 14, wherein the ninth transistor comprises a double-gate transistor, the first initialization module comprises a fourth transistor and a tenth transistor, and the fourth transistor is connected to the leakage suppression module through the tenth transistor;
the active layer of the eighth transistor is located between the active layer of the ninth transistor and an active layer of the tenth transistor, the active layer of the eighth transistor and the active layer of the ninth transistor are connected through the first connection part, and the active layer of the eighth transistor and the active layer of the tenth transistor are connected through a third connection part;
the first connection part, the third connection part, the active layer of the eighth transistor, the active layer of the tenth transistor, and the active layer of the ninth transistor are located in a same film layer;
the third connection part is a semiconductor connection part,
wherein a gate of the fourth transistor is connected to a first scanning signal line, and a gate of the tenth transistor is connected to a leakage control signal line;
the leakage control signal line extends in a first direction, and the gate of the eighth transistor, the gate of the tenth transistor and the gate of the ninth transistor are connected to a same leakage control signal line.

18. The display panel according to claim 17, wherein the drive module comprises a first transistor, the eighth transistor is connected to a gate of the first transistor through a second connection part, and a connection hole between the eighth transistor and the second connection part is located on a side of the leakage control signal line away from the first transistor;
the first connection part and the third connection part are located on a side of the leakage control signal line near the first transistor.

19. The display panel according to claim 14, wherein a first electrode of the eighth transistor is connected to the control terminal of the drive module, the eighth transistor comprises a double-gate transistor, and the pixel circuit further comprises a first capacitor and a second capacitor;
a first terminal of the first capacitor is connected to a double-gate node of the eighth transistor, and a second terminal of the first capacitor is connected to a first power line or a reference signal line;
a first terminal of the second capacitor is connected to a second electrode of the eighth transistor, and a second terminal of the second capacitor is connected to the first power line or the reference signal line,
wherein a capacitance value of the first capacitor is 10 fF to 60 fF, and a capacitance value of the second capacitor is 10 fF to 60 fF.

20. The display panel according to claim 14, wherein the pixel circuit further comprises a data writing module, a storage module, a first light-emitting control module and a second light-emitting control module;
the data writing module is connected between a data signal line and a second terminal of the drive module, the storage module is connected between the control terminal of the drive module and a first power line, the first light-emitting control module is connected between the first power line and the second terminal of the drive module, and the second light-emitting control module is connected between a first terminal of the drive module and a first electrode of a light-emitting element of the display panel;
the drive module comprises a first transistor, the data writing module comprises a second transistor, the second submodule comprises a third transistor, the first initialization module comprises a fourth transistor, the first light-emitting control module comprises a fifth transistor, and the second light-emitting control module comprises a sixth transistor;
a gate of the fourth transistor is connected to a first scanning signal line, a gate of the second transistor and a gate of the third transistor are connected to a second scanning signal line, a gate of the fifth transistor and a gate of the sixth transistor are connected to a light-emitting control signal line, and the gate of the eighth transistor and the gate of the ninth transistor are connected to a leakage control signal line.
